(19) United States
(12) Patent Application Publication
(10) Pub. No.: US 2014/0211370 A1
(43) Pub. Date: Jul. 31, 2014

(54) Electrochemical Cell, Related Material, Process for Production, and Use Thereof

(71) Applicant: Fraser Seymour, Middletown, MD (US)

(72) Inventors: Fraser Seymour, Middletown, MD (US); Evan Benbow, Fort Mill, SC (US)

(73) Assignee: IONOVA TECHNOLOGIES, INC., Middletown, MD (US)

(21) Appl. No.: 14/163,352

(22) Filed: Jan. 24, 2014

Related U.S. Application Data
(63) Continuation-in-part of application No. 14/139,421, filed on Dec. 23, 2013.
(60) Provisional application No. 61/756,506, filed on Jan. 25, 2013.

(51) Int. Cl. H01G 9/22; H01G 9/035; H01G 9/00; H01G 9/025

(52) U.S. Cl. CPC H01G 9/22; H01G 9/025; H01G 9/035; H01G 9/0029
USPC 361/504; 361/525; 361/526; 361/434; 29/25.03

(57) ABSTRACT

The present invention relates to an electrochemical energy storage device referred to herein as a Metal/Ion Pseudo-Capacitor (MIPC). The MIPC stores charge through reversible metal electro-deposition and dissolution processes as anode functionality and ion adsorption/desorption processes, faradaic processes or both as cathode functionality.

### CROSS-REFERENCE TO RELATED APPLICATIONS

This application claims the benefit of provisional U.S. application identified by application No. 61,756,508 filed on Jan. 25, 2013, and claims priority thereto; the foregoing application being incorporated herein by reference. This application also is a continuation-in-part of non-provisional U.S. application identified by application Ser. No. 14/139,421 filed on Dec. 23, 2013, and claims priority thereto; the foregoing application being incorporated herein by reference.

### NOTICE OF GOVERNMENT RIGHTS

This invention was made with government support under DE-SC0002485 awarded by the U.S. Department of Energy (the “Government”). The Government has certain rights in this invention.

### FIELD OF THE INVENTION

The present invention relates to an electrochemical energy storage device referred to herein as a Metal/Ion Pseudo-Capacitor (MIPC). The MIPC stores charge through reversible metal electro-deposition and dissolution processes as negative electrode (anode) functionality and ion adsorption/desorption processes, faradaic processes or both as positive electrode (cathode) functionality.

### BACKGROUND OF THE INVENTION

Electrochemical capacitors (EC, sometimes referred to in the art as ultra-capacitors, super-capacitors or pseudo-capacitors) are energy storage devices generally characterized by the ability to charge and discharge at equivalent rates (rate symmetry) and exhibit a near-proportional relationship between state of charge and voltage (potential/charge proportionality). ECs also exhibit more rapid charge/discharge rates, greater energy efficiency and longer cycle life versus rechargeable (secondary) batteries, for example.

A typical EC cell comprises a pair of electrodes, a separator that is an ionic conductor but an electronic insulator placed between these electrodes; all of these components infused with electrolyte that contains and conducts ions to facilitate charge storage at the electrodes. Electrodes are typically fabricated as films formed from a paste comprising powdered active material, binder and conductivity-enhancing carbon powder, and adhered to an electrically conductive current-collector material. Typical electrolytes comprise salts of alkali metals in liquid solvents, but may alternatively be ionic liquids. Non-liquid forms of electrolytes include solid or gel polymers or solid ceramic, for example.

ECs typically store charge at or near the interface between the electrolyte and the electrode material, thus permitting the aforementioned performance characteristics. They typically use electrostatic ion adsorption (electric double-layer), surface faradaic pseudo-capacitance, or bulk intercalation systems for charge storage. EC devices that rely exclusively on ion adsorption for charge storage in both positive and negative electrodes are referred to as electric double layer capacitors (EDLCs). EDLCs utilize symmetric electrodes typically comprising activated carbon or other carbon exhibiting large specific surface area as the active material. EC devices that use an electric double layer electrode and a pseudo-capacitive or intercalation electrode are referred to as asymmetric ECs. For example, the so-called lithium-ion capacitor (LIC) is a form of asymmetric EC that uses intercalation-based anode materials such as hard carbon, graphite or lithium titanate with a carbon material providing electric double layer charge storage for the cathode.

The amount of charge stored by ion adsorption is related to the interfacial surface area of the electrode active material which is accessible by the electrolyte ions. Activated carbon electrodes, for example, typically have specific surface areas between 1000 and 3000 m²/g achieved with a high concentration of micropores (pore diameter less than 2 nm) and ultra-micropores (pore diameter less than 0.7 nm) for the larger specific surface area carbons. In general, specific surface area is inversely related to pore size.

Surface-area normalized capacitance (farads/cm² or simply F/cm² of the electrode), is a metric used to quantify the double-layer electrode charge storage. The theoretical upper limit for activated carbon, for example, is ca. 25 uF/cm², but practical values range from ca. 6.5-8 uF/cm² to ca. 10-15 uF/cm² for aprotic and aqueous electrolytes respectively. The difference between theoretical and practically realized capacitance is due to inaccessibility of electrolyte (solvated) ions to the electrode's smallest, more tortuous or blocked pores.

Pseudo-capacitance involves charge transfer through rapid oxidation/reduction (redox) reactions occurring at or near the surface of the electrode active material over a potential (voltage) range and with a current vs. voltage response similar to that of the EDLC. Materials capable of providing pseudo-capacitive behavior include functionalized carbon, graphitic carbon, conductive polymers and transition metal oxides.

Carbon may be doped or otherwise augmented with additional elements and related functional groups to induce pseudo-capacitive behavior. Other behavioral modifications possible through functionalization include the alteration of hydrophobicity, electronic conductivity, irreversible oxidation, and the gas evolution potential of the electrode material.

Other materials exhibiting pseudo-capacitive behavior include electro-active polymers such as polypyrrole, polyaniline, polythiophene, poly-1,5-diaminoanthraquinone, polyquinoxaline, polyindole, cyclic indole trimers, polyacene, polyacetylene, poly(vinylpyridine) and tetramethylpyridine, for example, and transition metal oxides such as manganese oxide or nickel oxide, and transition metal hexacyanometalates including metal hexacyanoferrates, metal hexacyanotitanates, metal hexacyanocobaltates, or metal hexacyanomanganates for example.

In an EC cell, the electrodes are considered to be electrically in series so the cell voltage is equal to the sum of the voltage across each of the electrodes and the cell capacitance is equal to the reciprocal of the sum of the reciprocal of the capacitance of each electrode. For example, if the anode and the cathode each provide identical capacitance, then the capacitance accounting for both electrodes will be equal to half of the electrode capacitance. Since there are two electrodes in a cell, the capacitance as normalized to the summation of the mass or volume of both electrodes, is about one quarter of the mass or volume normalized capacitance on one electrode.

Asymmetric ECs generally provide greater energy per unit mass, volume and cost versus EDLCs. This is a result of greater cell capacitance and voltage, greater materials density as well as lower materials costs versus EDLCs. The capacitance per unit mass and volume of a non double-layer electrode is typically larger than that of a double-layer electrode, providing the asymmetric EC cell with greater capacitance. Since non double-layer electrode materials typically operate at potentials that are beyond that of double-layer materials, asymmetric cells typically possess greater cell voltages. In certain cases, non double-layer materials can be significantly lower cost versus activated carbon and other double-layer materials. Further, some non double-layer materials operate in low-cost aqueous (water-based) electrolytes that have the benefit of a much cheaper manufacturing techniques.

Pure water possesses a thermodynamic stability window of 1.23V, beyond which hydrogen evolution reaction (HER), oxygen evolution reaction (OER) or both are possible. This window can be manipulated through a variety of factors such as pH, electrolyte concentration, electrode current density and the inherent over-potential of the materials used in the electrode. The inherent over-potential of a material can allow for its electrochemical operation outside the aforementioned stability window without significant gas evolution.

Electrode materials with large surface area can trap gas evolved, effectively storing the gas until the electrode reaches a potential at which the gas is electrochemically recombined with the electrolyte through oxidation or reduction. This is the case for hydrogen evolved on high surface area carbon anodes when cycled through appropriate electrochemical potentials.

Unlike high surface area carbon-based electrode materials, battery-like electrode materials lack sufficient surface area to permit trapping of evolved gas. Also, the electrochemical potential of this type of electrode is relatively constant, thus preventing the reverse reaction from occurring at the gas-evolving electrode. Therefore, it is necessary to facilitate gas transport between the electrodes, which will allow the gas generated at one electrode to undergo oxidation or reduction at the other electrode. Such is the definition of a recombinant electrochemical energy storage system: gas is transported between electrodes and recombined to form the initial non-gaseous electrolyte species.

An example of such a situation is observed in sealed lead acid batteries that employ gel electrolytes or an absorbed glass mat (AGM) separator, either of which facilitate gas transport between the electrodes. The gel electrolyte facilitates the transport of the evolved gas via cracks formed during the electrolyte gelation process. The AGM, on the other hand, operates wherein the AGM is not completely saturated with electrolyte, thus providing pathways for gas transport. Oxygen gas evolved at the lead acid battery cathode is transported to the anode where it depolarizes the anode by the reduction of the oxygen gas at the surface of the anode, ultimately recombining to form H₂O.

Another example is an aqueous cell utilizing a metal/ion deposition/dissolution anode. In this case, hydrogen gas is evolved on the surface of the anode-plated metal since it is operated below the standard hydrogen potential. The amount of hydrogen evolved will vary with the inherent hydrogen evolution over-potential of the metal, the electrolyte pH, and the electrochemical potential at which is held, among other factors. If the hydrogen is transported to the cathode, it will become oxidized, recombining to form the initial non-gaseous species. Thus, a recombinant system is an effective way to maintain the stability of an electrochemical system based upon an aqueous electrolyte while utilizing electrochemical potentials that exceed the thermodynamic stability of water, providing long calendar life, long cycle life and safety.

The metal deposition component of the anode functionality can occur above or below the standard redox potential for a given metal as under-potential and over-potential deposition modes respectively. The deposition mode affects the morphology of the plated metal species and HER activity at the deposition site or substrate. Factors affecting deposition mode include electrolyte ion concentration, ion species, ion complexes and ion mixture ratios; solvent; electrolyte pH; electrolyte agitation; temperature; and deposition site material. While these factors can affect the deposition mode by affecting the deposition potential, the corresponding dissolution potential generally likewise shifts so the difference between the deposition and dissolution potentials remains relatively constant. Other factors affecting deposition mode include current density and the use of organic or inorganic electrolyte additives; however, increased current densities and the use of such additives not only increase the deposition potential excursion, but also may increase the dissolution potential excursion relative to the deposition potential. Such electrolyte additives can alter the morphology of the deposited metal species. In the case of an electrochemical storage device such as an MIPC, it is advantageous to maintain the least possible differential between deposition and dissolution potentials as these correlate to charge/discharge voltage hysteresis and decreases energy storage efficiency. Also in the case of an MIPC, it is advantageous to maintain the largest margin between the deposition site potential and the potential at which HER is favored.

There remains a need in the art for EC devices capable of storing greater amounts of energy per unit mass, per unit volume and per unit cost without compromising safety or charge/discharge rates.

### SUMMARY OF THE INVENTION

It is an object of the present invention to provide an energy storage device exhibiting a greater amount of energy stored per unit mass, per unit volume and per unit cost versus that of commercially available EDLCs.

It is another object of the present invention to provide an energy storage device that shares the EC behavioral characteristics of fast charge rates or rate symmetry, excellent charge/discharge energy efficiency, excellent cycle life and potential/charge near proportionality.

It is yet another object of the present invention to provide a method of manufacture of an energy storage device with increased energy stored per unit mass, per unit volume and per unit cost.

It is an advantage of the present invention that the anode functionality provides very large capacity versus other methods of storing electrochemical energy.

It is another advantage of the present invention to provide an energy storage device that is capable of being manufactured by a variety of means including those generally employed to produce prismatic or wound capacitors or batteries, or bipolar series construction.

The aforementioned objects and advantages are satisfied by a Metal/Ion Pseudo-Capacitor as provided, comprising at least one cell further comprising at least one cathode and current collector, at least one conductive anode deposition substrate (ADS) and current collector function, the ADS opposing said cathode, and a multi-functional electrolyte system. Said MIPC may also comprise a separator film providing electrical isolation, ionic conduction and, in certain embodiments, gas transport between each pair of said cathode and ADS. Said ADS may optionally perform the additional function of anode current collector.

During the charge process, cations from the MIPC multifunctional electrolyte that provide anode functionality (anode redox metal/cation M) are electrochemically reduced to solid metal phase on the active surface of the ADS. This process is generally reversed during discharge as the metal is oxidized to cation species and dissolved into the electrolyte. These reduction and oxidation processes occur about an electrochemical equilibrium potential, which is related to the standard redox potential for the anode material and other factors that can provide under-potential or over-potential deposition modes.

The MIPC ADS may comprise M so as to allow the discharge capacity of the MIPC to exceed the capacity provided by M deposited during charge processes alone. The MIPC ADS may comprise M, an alloy of M, one or more other metals, graphite foil or any combination thereof.

In the case where electric double-layer is the predominant charge storage mechanism of the MIPC cathode, anions from the electrolyte are adsorbed during the charge process and desorbed at the surface of the cathode during discharge when said charge and discharge occur at electrochemical potentials above the open-circuit potential of the cathode. At potentials below the open-circuit potential of the cathode, cations are adsorbed during discharge and desorbed during charge.

Alternatively, the predominant charge storage mechanism of the MIPC cathode may be faradaic in the form of pseudo-capacitance or fast intercalation. Here, charge storage is generally accomplished through surface or near-surface cation insertion into and extraction from the cathode active material during discharge and charge respectively.

The electrolyte system is multi-functional in that it provides ionic species in support of each and all of the multiple charge storage processes that take place within the MIPC, which is in any case more than one charge storage process.

MIPC M anode material is chosen such that the difference between the anode equilibrium potential and the operating potential of the cathode is a large as possible while maintaining electrochemical stability within the cell. In this way, it becomes possible to obtain a cell voltage that exceeds a cell voltage that is obtainable with an EDLC of similar electrolyte.

The MIPC M anode charge storage mechanism provides a large electrochemical capacity over a narrow electrochemical potential range, which corresponds to an extremely large specific and volumetric capacitance; it is more than 100-fold larger than that of the MIPC cathode. Accordingly, the overall cell capacitance approaches that of the cathode itself, when normalized to the physical properties of both electrodes represents about a 4-fold increase versus an EDLC.

As used herein “substantially”, “generally”, “relatively”, “approximately”, and “about” are relative modifiers intended to indicate permissible variation from the characteristic so modified. It is not intended to be limited to the absolute value or characteristic which it modifies but rather approaching or approximating such a physical or functional characteristic.

References to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

In the following description, reference is made to the accompanying drawings, which are shown by way of illustration to specific embodiments in which the invention may be practiced. The following illustrated embodiments are described in sufficient detail to enable those skilled in the art to practice the invention.

It is to be understood that other embodiments may be utilized and that structural changes based on presently known structural and/or functional equivalents may be made without departing from the scope of the invention.

Hereinafter, various embodiments of the present invention will be explained in more detail with reference to the accompanying figures; however, it is understood that the present invention should not be limited to the following preferred embodiments and such present invention may be practiced in ways other than those specifically described herein.

### BRIEF DESCRIPTION OF THE DRAWINGS

FIGS. 1-5 illustrate four example embodiments of a MIPC and components thereof. According to the present invention, a MIPC cell comprises at least one cathode/current collector function, at least one ADS/current collector function, a multi-functional electrolyte, and a separator function. Said MIPC separator function may further comprise a separator film as depicted in the figures or by other means described herein. It is understood that a MIPC cell may comprise any number of ADS or cathode functions and a MIPC device may contain any number of MIPC cells in any configuration. FIGS. 6-8 illustrate a laminate current collector and a laminate ADS. FIGS. 9-13 illustrate electrochemical charge storage behavior of one MIPC embodiment which utilizes a zinc-based anode function, a combined adsorption/faradaic carbon cathode function and a mildly acidic aqueous electrolyte comprising chlorides of zinc and sodium. FIGS. 14-15 illustrate alternative cathode materials comprising a carbon which has been functionalized with surface layers of manganese oxides.

FIG. 1 depicts a constitutional drawing cross-sectional view of the MIPC in a single cathode, single ADS configuration. 1 represents the cathode current collector, 2 represents the cathode, 3 represents the optional separator film, 4 represents the unitary anode current collector/deposition substrate upon which the anode metal M which is reduced from ionic form present in the multi-functional electrolyte, is deposited. Items 2 and 3 are infused with and item 4 is in contact with said multi-functional electrolyte.

FIG. 2 depicts a constitutional drawing cross-sectional view of the MIPC in a single cathode, single ADS configuration with an anode current collector discrete from the ADS. 1 represents the cathode current collector, 2 represents the cathode, 3 represents the optional separator film, 4 represents the ADS upon which the anode metal M which is reduced from ionic form present in the multi-functional electrolyte, is deposited. 5 represents the discrete anode current collector attached to the ADS. Items 2 and 3 are infused with and item 4 is in contact with said multi-functional electrolyte.

FIG. 3 depicts a constitutional drawing cross-sectional view of the MIPC in a bi-polar (electrically in series) stack of two cells each comprising a single cathode, single ADS configuration. 1 represents the cathode current collector, 2 represents the cathodes, 3 represents the optional separator films, 4 represents the anode current collector/deposition substrate upon which the anode metal M which is reduced from ionic form present in the multi-functional electrolyte, is deposited. Items 2 and 3 are infused with and item 4 is in contact with said multi-functional electrolyte.

FIG. 4 depicts a constitutional drawing cross-sectional view of the MIPC in a multiple cathode (electrically in parallel), single ADS configuration. 1 represents the cathode current collector, 2 represents the cathodes, 3 represents the optional separator films, 4 represents the anode current collector/deposition substrate upon which the anode metal M which is reduced from ionic form present in the multi-functional electrolyte, is deposited. Items 2 and 3 are infused with and item 4 is in contact with said multi-functional electrolyte.

FIG. 5 depicts a constitutional drawing cross-sectional view of the MIPC in a multiple cathode, multiple ADS (electrically in parallel) configuration. 1 represents the cathode current collector, 2 represents the cathodes, 3 represents the optional separator films, 4 represents the anode current collector/deposition substrates upon which the anode metal M which is reduced from ionic form present in the multi-functional electrolyte, is deposited. Items 2 and 3 are infused with and item 4 is in contact with said multi-functional electrolyte.

FIG. 6 depicts a constitutional drawing cross-sectional view of a laminate MIPC current collector comprising two graphite foil sheets 1, a metal plane 2 therebetween, and an edge seal 3.

FIG. 7 depicts a constitutional drawing cross-sectional view of a laminate MIPC ADS comprising a foil, which has been perforated to form a honeycomb morphology. In this exemplary embodiment, said laminate ADS performs the roles of: ADS, ADS current collector, and separator, and accommodates a cathode on each side (i.e. two cathodes). 3 represents the solid foil material, 4 represents the void space open to the MIPC electrolyte, 5 represents the electrochemically active ADS surfaces, 6 represents the metal extending beyond the cell interior as a current collector tab, 2 represents the electrochemically inactive ADS surfaces and 1 represents the barrier coating.

FIG. 8 depicts a constitutional drawing cathode-facing view of a laminate MIPC ADS comprising a foil, which has been perforated to form a honeycomb morphology. 1 represents the barrier coating, 2 represents the electrochemically active ADS surface void space wall, 3 represents the metal extending beyond the cell interior as a current collector tab, and 4 represents the ADS void space forming a micro-cell.

FIG. 9 depicts a charge cycle followed by a discharge cycle, each using galvanostatic constant current between 0.85V and 1.7V. The figure demonstrates capacitor-like behavior of an example MIPC using a porous carbon cathode paired with a zinc metal foil ADS/current collector in an aqueous electrolyte comprising chlorides of zinc and sodium.

FIG. 10 depicts two galvanostatic charge/discharge cycles between 0.36V and 1.8V. The figure demonstrates capacitor-like behavior of an example MIPC using a porous carbon cathode paired with a zinc metal foil ADS/current collector in an aqueous electrolyte comprising chlorides of zinc and sodium.

FIG. 11 depicts a charge and a discharge cycle using cyclic voltammetry between 0.9V and 1.8V. The figure demonstrates capacitor-like behavior of an example MIPC using a porous carbon cathode paired with a zinc metal foil ADS/current collector in an aqueous electrolyte comprising chlorides of zinc and sodium.

FIG. 12 depicts a charge and discharge cycle of a zinc metal foil ADS/current collector using cyclic voltammetry in an aqueous electrolyte comprising chlorides of zinc and sodium.

FIG. 13 depicts two charge and discharge cycles of a cathode comprising a nitrogen-doped porous carbon using cyclic voltammetry in an aqueous electrolyte comprising chlorides of zinc and sodium. Here, the MIPC cathode was charged from −700 mV (versus Ag/AgCl) to +900 mV in one case, and from 0V to +900 mV in a second case. This figure illustrates the effect of potential upon the capacitance of the exemplary cathode.

FIG. 14 depicts two charge and discharge cycles of a cathode comprising a nanoscopic coating of manganese oxide of generally alpha phase upon a porous carbon using cyclic voltammetry in an aqueous electrolyte comprising chlorides of zinc and sodium. The electrode is charged and discharged between 0.25V and 0.90V versus Ag/AgCl reference electrode.

FIG. 15 depicts charge and discharge cycles of a cathode comprising a nanoscopic coating of a cation doped manganese oxide of generally spinel phase upon a porous carbon in an aqueous lithium chloride electrolyte. The electrode is charged and discharged between 0.2V and 1.1V versus Ag/AgCl reference electrode using cyclic voltammetry at of 2, 5 and 10 mV/S.

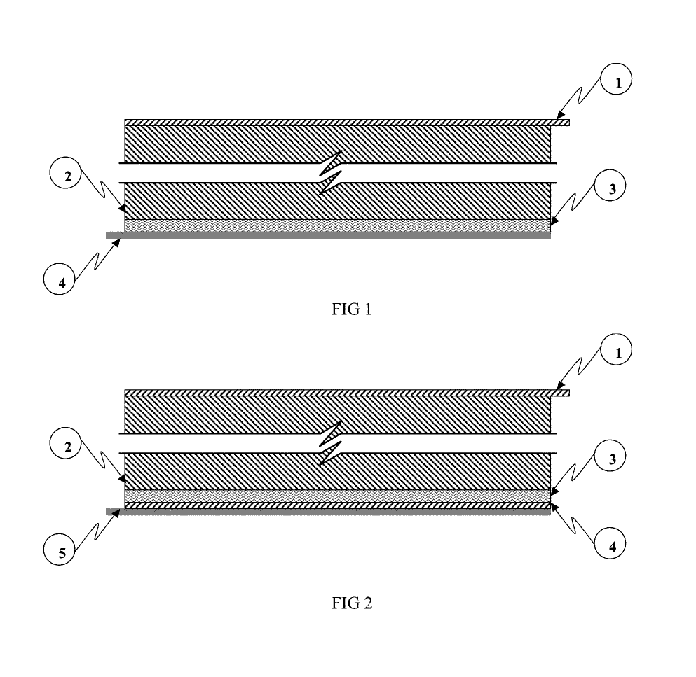

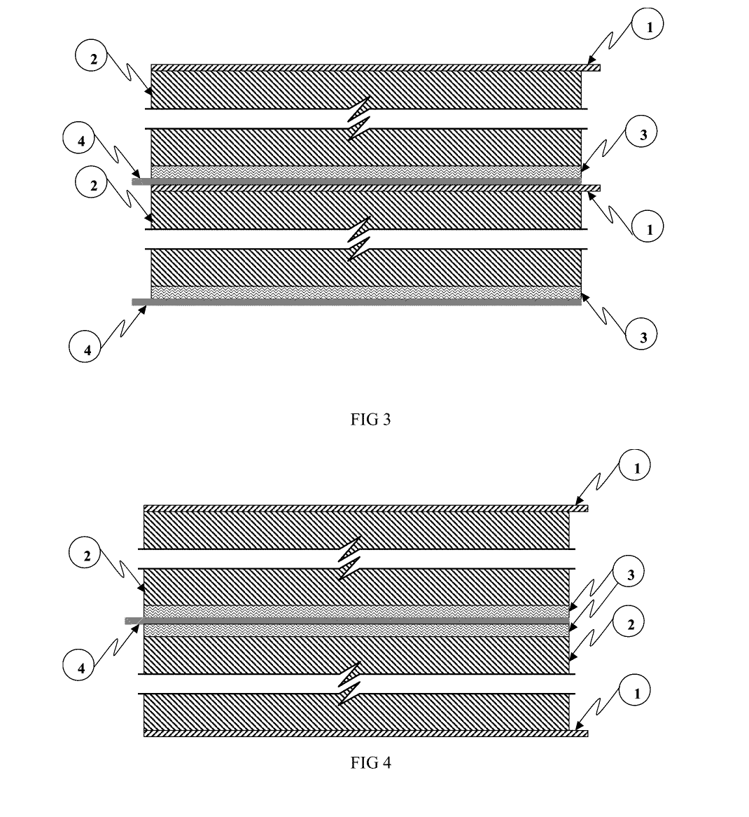

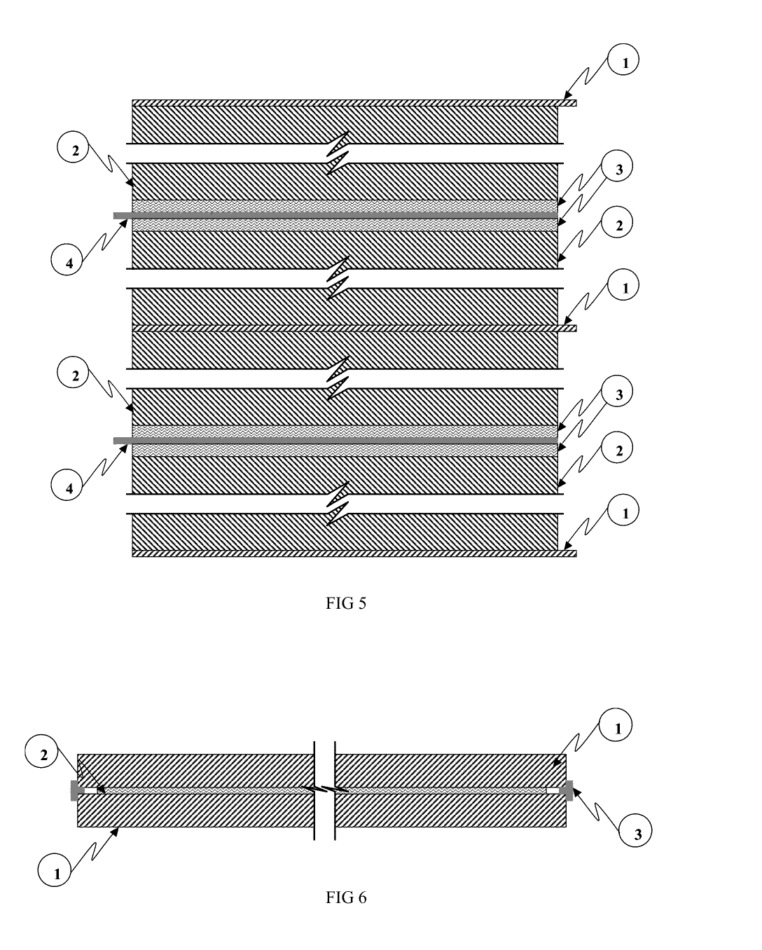

### DETAILED DESCRIPTION OF THE INVENTION

The present invention relates to a Metal/Ion Pseudo-Capacitor (MIPC) comprising a multi-functional electrolyte, an anode deposition substrate (ADS), a cathode, a cathode current collector, a separator function, an anode current collector function, a positive terminal, a negative terminal, and packaging. Said MIPC may also include a pressure relief valve. The MIPC stores electric charge by employing a multi-functional electrolyte comprising at least one redox-active cation component (M) which provides anode functionality through reversible metal electro-deposition and dissolution processes that occur upon the electrochemically active surface of the aforementioned ADS, and pairs this with the aforementioned cathode employing ion adsorption/desorption processes, faradaic processes or both faradaic and adsorption/desorption processes.

Said multi-functional electrolyte comprises at least one cation species, at least one anion species, and comprises at least one composition selected from a group consisting of ionic liquid, salt and polymer, salt and ceramic, salt and liquid solvent and polymer as a gel, salt and liquid solvent and fumed silica as a gel, and salt and liquid solvent, wherein the liquid solvent comprises at least one selected from a group consisting of water and organic liquid.

The aforementioned anode functionality is provided by at least one redox-active component M of said multi-functional electrolyte, wherein M is at least one cation species, each comprising at least one selected from a group consisting of cation species of tin (Sn), nickel (Ni), cobalt (Co), titanium (Ti), indium (In), lead (Pb), chromium (Cr), iron (Fe), gallium (Ga), tantalum (Ta), zinc (Zn), niobium (Nb), vanadium (V), manganese (Mn), zirconium (Zr), aluminum (Al), magnesium (Mg), sodium (Na), calcium (Ca), strontium (Sr), barium (Ba), potassium (K), lithium (Li) and hydrogen (H).

The aforementioned multi-functional electrolyte may contain at least one cation species (C) in addition to M, such that the additional cation species is not the principal anode charge storage cation of the MIPC, and is selected from a group consisting of cation species of Sn, Ni, Co, Ti, In, Pb, Cr, Fe, Ga, Ta, Zn, Nb, V, Mn, Zr, Al, Mg, Na, Ca, Sr, Ba, K, Li, bismuth (Bi), germanium (Ge), copper (Cu), hydronium, nitrogen (N), ammonium, and organic complex.

Said multi-functional electrolyte contains at least one anion species selected from a group consisting of chloride (Cl⁻); sulfate (SO₄²⁻); nitrate (NO₃⁻); hydroxide (OH⁻); bis(trifluorosulfonyl)imide (TFSI⁻); bis(fluorosulfonyl)imide (FSI⁻); hexafluorophosphate (PF₆⁻); trifluoromethanesulfonate (CF₃SO₃⁻); methanesulfonate (CH₃SO₃⁻); bis(oxalato) borate (BOB⁻); tris(pentafluoroethyl)trifluorophosphate (FAP⁻); tetrafluoroborate (BF₄⁻); perchlorate (ClO₄⁻); hexafluoroarsenate (AsF₆⁻); bromide (Br⁻); iodide (I⁻); bis(pentafluoroethyl sulfonyl)imide (BETI⁻); dicyanotriazolate (DCTA); 4,5-dicyano-2-(trifluoromethyl)imidazole (TDI⁻); tetrachloroaluminate (AlCl₄⁻); hexafluoroantimonate (SbF₆⁻); thiocyanate (SCN); trifluoroacetate (CF₃CO₂⁻); bis(trifluoromethanesulfonimide) (N(CF₃SO₂)₂⁻); bis(trifluoromethylsulfonyl)imide (NTf₂⁻); and tetraphenylborate (B(C₆H₅)₄⁻).

Said organic liquid solvent is at least one selected from a group consisting of ethylene carbonate (EC); fluoroethylene carbonate (FEC); propylene carbonate (PC); diethyl carbonate (DEC); diethyl ether (DE); 1,2-dimethoxy ethane (DME); ethyl methyl carbonate (EMC); dimethyl carbonate (DMC); ethylene glycol (EG); diethylene glycol dimethyl ether (DGD); diethylene glycol diethyl ether (DGDE); diethylene glycol dibutyl ether (DEDB); dipropylene glycol dimethyl ether (DPGDME); 1,2-diethoxyethane (DEE); 1-tert-butoxy-2-ethoxyethane (BEE); tetramethylene sulfolane (TMS); fluoro methyl sulfone (FMS); dimethyl sulfoxide (DMSO); acetonitrile (AN); tetrahydrofuran (THF); 2-methyl tetrahydrofuran (2-Me THF); methyl formate (MF); 1,3-dioxolane; gamma-butyrolactone (GBL); adiponitrile (ADN); succinonitrile (SCN); glutaronitrile (GLN); pimelonitrile (PMN); suberonitrile (SUN); sebaconitrile (SEN); methyl nonafluorobutyl ether (MFE); 2-trifluoromethyl-3-methoxyperfluoropentane (TMMP); 2-(trifluoro-2-fluoro-3-difluoropropoxy)-3-difluoro-4-fluoro-5-trifluoropentane (TPTP); and tris(2,2,2-trifluoroethyl) phosphite (TTFP).

Said ionic liquid is derived from imidazolium ion, pyridinium ion, pyrrolidinium ion, pyrazolium ion, or phosphonium ion; said ionic liquid is at least one selected from a group consisting of 1-ethyl-3-methylimidazolium bis(trifluoromethanesulfonyl)imide (EMITFSI), 1-ethyl-3-methylimidazolium tetrafluoroborate (EMIBF₄), 1-ethyl-3-methylimidazolium tetrafluoromethylsulfonate (EMIM OTf), 1-ethyl-3-methylimidazolium bis(trifluoromethyl)sulfonylamide (EMIM BTA), 1-methyl-1-propylpyrroldinium bis(trifluoromethylsulfonyl)amide (PMPyrr BTA), 1-ethyl-3-methylimidazolium bis(trifluoromethylsulfonyl)amide (EMIM-NTf₂), N-methyl-N-propylpyrrolidinium bis(trifluoromethanesulfonyl)imide (PYR₁₃TFSI), 1-allyl-3-methylimidazolium tetrachloroaluminate, 1-(3-cyanopropyl) pyridinium tetrachloroaluminate, 1-butyl-1-methylpyrrolidinium tetraaluminate, 1,2,4-trimethylpyrazolium tetraaluminate, and triphenylmethylphosphonium tetraaluminate.

Said multi-functional electrolyte polymer component is at least one selected from a group consisting of poly(methyl methacrylate) (PMMA); poly(vinyl alcohol) (PVA); polysiloxane (PSO); poly(ethylene oxide) (PEO); polysulfone (PSU); poly(oligo oxyethylene methacrylate) (PMEO); polyimide (PI); polyamide (PA); polyester (PET); polypropylene (PP); polyethylene napthalate (PEN); polyethylene glycol (PEG); polycarbonate (PC); polyacrylonitrile (PAN); polyphenylene sulfide (PPS); polytetrafluoroethylene (PTFE); polyvinylidene fluoride (PVDF); potassium polyacrylate (PAAK); polyacrylamide (PAAM); fumed silica; and cellulose.

Said MIPC separator function allows the transport of ionic species contained in the electrolyte to and from the electrochemically active surfaces of the ADS and the cathode while obstructing electron flow between the cathode and ADS, wherein said separator function is performed by at least one material or any combination of materials selected from a group consisting of: a solid polymer electrolyte; a gel polymer electrolyte; a solid ceramic electrolyte comprising one or more elements selected from a group consisting of Na, Al, Ti, Zr, Ca, Mg, Ge, In, Li, Zn, silicon (Si), yttrium (Y), cerium (Ce), and hafnium (Hf) and one or more elements selected from a group consisting of hydrogen (H), oxygen (O), phosphorous (P), sulfur (S), and nitrogen (N); the material Beta Alumina, LiPON, LISICON, NASICON, thiophosphates, nanostructured beta Li₃PS₄, partially substituted thiophosphates, Li₁₀GeP₂S₁₂; a porous separator sheet comprising at least one material selected from a group consisting of polyester (PET), polypropylene (PP), polyethylene napthalate (PEN), polycarbonate (PC), polyphenylene sulfide (PPS), polytetrafluoroethylene (PTFE), polyvinylidene fluoride (PVDF), cellulose fiber, glass fiber, and absorbed glass mat (AGM); and a barrier coating which is adhered to electrochemically inactive surfaces of the ADS for the purpose of preventing contact between said inactive ADS surfaces and the electrolyte, thereby preventing inactive ADS surfaces from participating in electro-deposition/dissolution processes, a second purpose of said barrier coating is to prevent electrical contact between the ADS and cathode, such barrier coating comprises at least one layer of at least one material selected from a group consisting of inorganic material, ceramic material, organic material, epoxy, and polymer; a spacer coating which is adhered to the selected surfaces of the ADS for the purpose of providing a controlled distance between electrochemically active ADS surfaces and cathode, thereby preventing electrical contact between the ADS and cathode, such spacer coating comprises at least one material selected from a group consisting of inorganic material, ceramic material, organic material, epoxy, and polymer; and any combination thereof. In MIPC embodiments wherein said electrolyte includes water as a solvent or as a co-solvent, said separator function further permits the transport of any gas species which is evolved upon the surfaces of said ADS, said cathode, or both the ADS and cathode, to be transported between the two for the purpose of recombination with the electrolyte. In particular, said gas transport function is provided by void areas within said absorbed glass mat, ADS barrier coating, silica gel electrolyte, polymer gel electrolyte, solid polymer electrolyte, and combinations thereof.

The MIPC ADS comprises electrochemically active surfaces and may additionally contain electrochemically inactive surfaces, and further comprises at least one material selected from a group consisting of: glassy carbon, graphitic carbon, solid state metal of M or alloy of M, and a solid state material comprises material A or any combination of material A and material B, wherein material A comprises one or more selected from a group consisting of Sn, Ni, Co, Ti, In, Pb, Cr, Fe, Ga, Ta, Zn, Nb, V, Mn, Zr, Al, Mg, Na, Ca, Sr, Ba, K, Li, Cu, wherein material B comprises one or more selected from a group consisting of Bi, Ge, Si, O, P, N, Ga, S, molybdenum (Mo), carbon (C), boron (B), antimony (Sb), and selenium (Se). The mechanical form of said ADS comprises one form or any combination of forms selected from a group consisting of layered laminate, foil, textured foil, patterned foil, etched foil, perforated foil, honeycomb foil, expanded foil, wire mesh, solid foam structure, polymer-bound foam powder composite, solid structure formed from sintered, partially melted or melted powder, and polymer-bound powder composite.

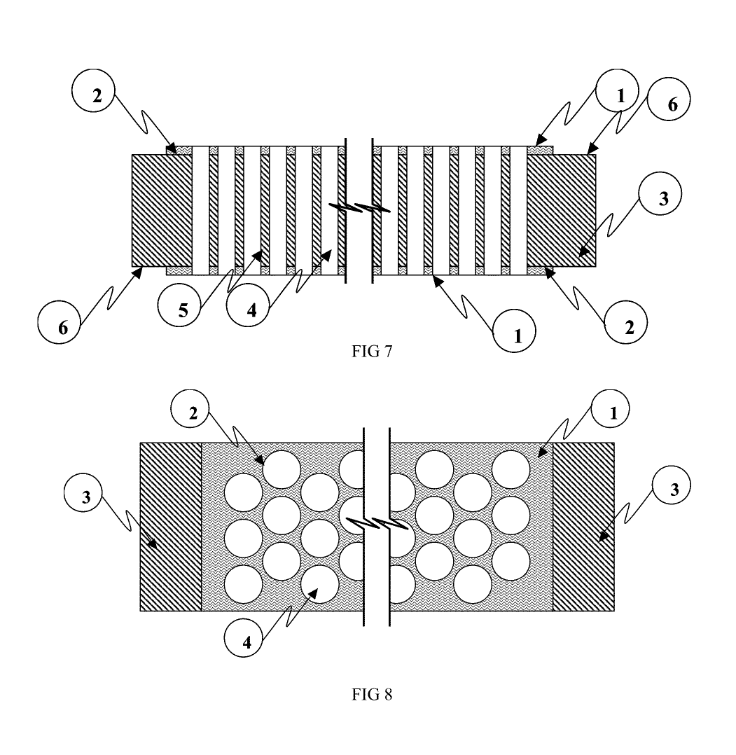

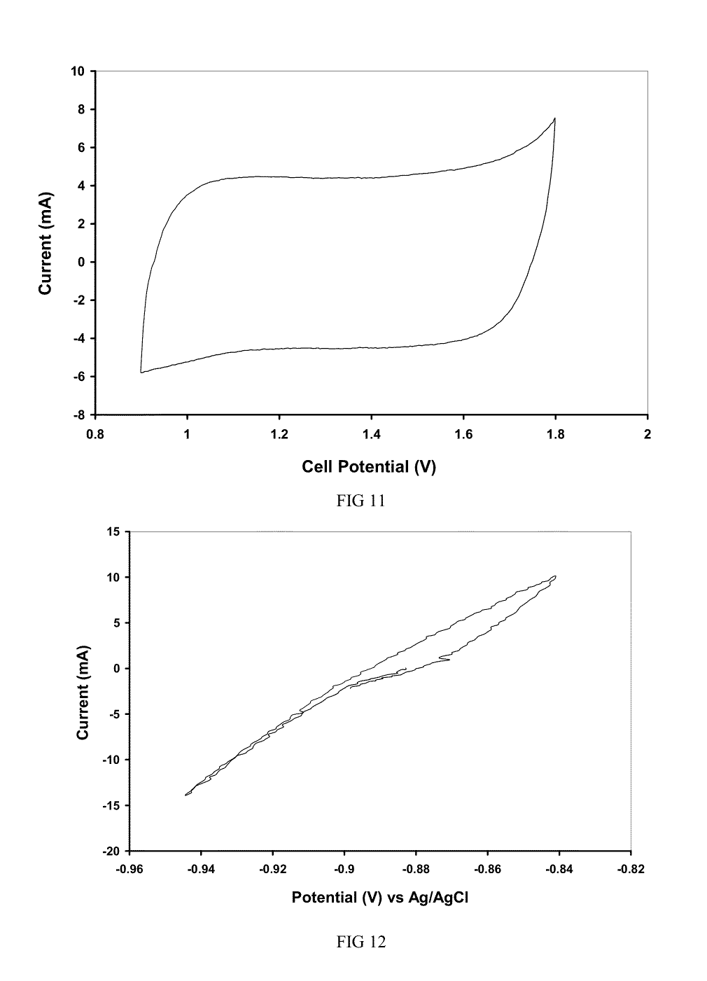

As shown in FIG. 12, the instantaneous potential of the ADS is related to the direction and area normalized density of the current applied to said MIPC and therefore also to said ADS. Since this potential change is related to the area normalized current density, it is advantageous that the ADS possess the largest surface area practicable. The morphology of the metal deposited upon said ADS is also related to the current density. In certain MIPC chemistries, for example, undesirable dendrite growth increases in relation to current density. This is true in the case of Li deposition, for example. Therefore, an embodiment of an MIPC includes an ADS possessing a larger usable surface area versus that available only from the geometric area derived from the length and width of the ADS area opposite the cathode, assuming a smooth foil surface. FIGS. 7 and 8 describe one embodiment of an ADS that can provide such an increase in deposition surface versus that of a smooth foil ADS. The ADS embodiment described in FIGS. 7 and 8 also orients deposition surfaces orthogonal to the MIPC cathode for the purpose of decreasing the likelihood of MIPC short circuit due to dendrite growth. The ADS embodiment described in FIGS. 7 and 8 also provides a barrier layer which inhibits depositing upon cathode-facing surfaces thereby further decreasing likelihood of MIPC short circuit. Other ADS embodiments are described herein that too address these issues.

An example embodiment of a MIPC ADS comprises a honeycomb foil possessing two planar surfaces, a thickness representing the linear distance between said planar surfaces, void space and solid space with inter-planar surfaces therebetween, wherein said void space, said solid space and said inter-planar surfaces generally maintain constant and continuous mechanical form between planar surfaces to create micro-cells, wherein the ratio of void space versus solid space is not particularly limited. The dimensions of the void space are not particularly limited; however, the preferred average width of said void space as measured across said void space is more than about 10 nm and less than about 100 um. The thickness of said ADS embodiment is not particularly limited; however, the preferred ADS thickness is greater than about 1 um and less than about 1 mm. The method of producing said ADS embodiment is not particularly limited, said method includes mold, template, spray printing, and foil which is modified by any method including expansion, mechanical hole drilling, laser hole drilling, fluid jet hole drilling, etching, photo-lithography, mechanical punching, and combinations thereof. The geometric shape of said ADS void space and therefore the geometric shape of the inter-planar surface is not particularly limited, and therefore may be any geometric shape including cylindrical; said inter-planar surface comprises the electrochemically active ADS surface and when combined with said void space comprise micro-cells wherein the deposition/dissolution processes occur. The planar surfaces of the example ADS embodiment are electrochemically inactive surfaces, and may be covered with a coating comprising one or more inorganic compound, one or more organic compound, or combinations thereof, wherein said coating thickness is not particularly limited, wherein said coating thickness is less than about 100 um and more than about 10 nm, wherein said coating does not generally occlude said void space opening across said planar surface or in any other way, wherein said coating inhibits a/ electron conduction between said ADS and the MIPC cathode, and b/ deposition and dissolution processes from occurring on said planar surfaces.

An example embodiment of a MIPC ADS comprises a coating upon the surface of a cathode current collector for the purpose of creating a stack of MIPC cells in an electrical series, wherein said cathode current collector is one or more selected from a group consisting of graphite foil, a composite comprising at least one metal layer between at least two layers of graphite foil, and a sealed foil or laminate, wherein said cathode current collector prevents access of the electrolyte of said adjacent cell to said ADS, wherein the coated surface is the surface opposite the surface used for the cathode of the adjacent cell, wherein the coating consists of a metallic phase of M or a metallic phase of an alloy of M, wherein the form of said ADS coating is one or any combination of forms selected from a group consisting of layered laminate, foil, textured foil, patterned foil, etched foil, perforated foil, honeycomb foil, expanded foil, wire mesh, solid foam structure, polymer-bound foam powder composite, solid structure formed from sintered or melted powder, and polymer-bound powder composite.

The aforementioned MIPC anode current collector function comprises a/ the aforementioned ADS, or b/ a current collector which is separate from the aforementioned ADS, said separate anode current collector is physically attached and electrically in contact with said ADS; wherein the mechanical form of said separate anode current collector is one or any combination of forms selected from a group consisting of foil, textured foil, patterned foil, etched foil, perforated foil, honeycomb foil, expanded foil, a layered laminate, wire mesh, solid foam structure, polymer-bound foam powder composite, solid structure formed from sintered, partially melted or melted powder, and polymer-bound powder composite; wherein said separate anode current collector comprises at least one material selected from a group consisting of glassy carbon, graphitic carbon, and a solid state material comprising material A or any combination of material A and material B, wherein material A comprises one or more selected from a group consisting of Sn, Ni, Co, Ti, In, Pb, Cr, Fe, Ga, Ta, Zn, Nb, V, Mn, Zr, Al, Mg, Na, Ca, Sr, Ba, K, Li, Cu, and alloys thereof, wherein material B comprises one or more selected from a group consisting of Bi, Ge, Si, O, P, N, Ga, In, Mo, C, B, S, Sb, and Se.

The method for preparing a MIPC wherein the prepared ADS is first attached to an anode current collector by means selected from a group consisting of applying heat, applying pressure, applying a conductive adhesive, welding, sintering, and combinations thereof.

A cathode active material comprising at least one carbon material having a specific surface area greater than 200 m²/g and less than 3000 m²/g; wherein said carbon material is at least one material selected from a group consisting of porous carbon, carbon microfibers, carbon nanofibers, carbon nanotubes, graphene, reduced graphene oxide, graphite, carbon black, and a carbon material derived from any combination thereof. Said porous carbon is one or more selected from a group consisting of polymer-derived carbon, carbide-derived carbon, activated cellulose-derived carbon, and templated carbon.

For MIPC embodiments wherein said electrolyte includes water as a solvent or co-solvent, said cathode carbon material is preferred to possess pores with average diameter greater than about 1 nm and an interconnected pore structure. These pore features promote transport of ionic species and also promote the transport of any evolved gas species. Further, in such an embodiment, said carbon is preferred to possess heteroatoms to impart certain functionalities. In one exemplary embodiment, the presence of nitrogen functional groups within the carbon matrix and upon the carbon surface increases electronic conductivity and induces pseudo-capacitance respectively; the presence of oxygen functional groups induces pseudo-capacitance; the presence of phosphorous increases the overpotential to gas evolution. The presence of heteroatoms provide the additional benefit of decreasing the occurrence of irreversible oxidation of said carbon material at elevated electrochemical potentials. Therefore, for MIPC embodiments employing such aqueous electrolytes, cathode carbon materials incorporating one or more heteroatoms N, O, and P are preferred.

The precursor material for said templated carbon comprises a templating agent, water and at least one selected from a group consisting of an aromatic hydrocarbon, a hydrolyzed benzene, an amine, an aniline, an aldehyde, a dialdehyde, a carbon, an acid, an hydroxide, a condensation/polymerization promoting catalyst, a gelatinous compound, a monosaccharide, a disaccharide, a oligosaccharide, a polysaccharide, a nitrogen-containing compound, a boron-containing compound, a phosphorous-containing compound, a sulfur-containing compound, and a magnesium-containing compound; examples of said precursors include melamine, PAN, PVA, hydroquinone, catechol, resorcinol, gelatin, agar, glucose, sucrose, fructose, aniline, nitrobenzene, chlorobenzene, benzene sulphonic acid, boric acid, phosphoric acid, sodium hydroxide, sodium carbonate, magnesium citrate, carbon microfibers, carbon nanofibers, carbon nanotubes, graphene, reduced graphene oxide, graphite, and carbon black.

The precursor material for said polymer-derived carbon comprises a condensation/polymerization promoting catalyst, water and at least two compounds selected from a group consisting of an aromatic hydrocarbon, a hydrolyzed benzene, an amine, an aniline, an aldehyde, a dialdehyde, a carbon, an acid, an hydroxide, a nitrogen-containing compound, a boron-containing compound, a phosphorous-containing compound, a sulfur-containing compound, and a magnesium-containing compound; examples of said precursors include melamine, hydroquinone, catechol, resorcinol, nitrobenzene, chlorobenzene, benzene sulphonic acid, boric acid, phosphoric acid, sodium hydroxide, sodium carbonate, magnesium citrate, carbon microfibers, carbon nanofibers, carbon nanotubes, graphene, reduced graphene oxide, graphite, and carbon black.

A cathode active material powder comprising an electro-active polymer, or electro-active polymer which is doped with at least one inorganic species. Said electro-active polymer is selected from a group consisting of polypyrrole (PPy), polyaniline (PANI), poly-3,4-ethylenedioxythiophene (PEDOT), poly(o-methoxyaniline) (POMA), poly-1,5-diaminoanthraquinone (PDAAQ), polyquinoxaline (PQ), polyindole (PIn), cyclic indole trimers (CIT), 5-carboxy CIT, 5-cyano CIT, polyacene (PAC), polyacetylene (PA), poly(vinylpyridine) (PVPy), tetramethylpyridine, polythiophene (PT), and derivatives and combinations thereof. The dopant of said electro-active polymer is at least one element selected from a group consisting of O, H, P, C, N, S, Mn, Ni, Co, Fe, Al, Cr, Mo, V, W, Ta, Pb, Sn, Ti, Cu, Zn, Nb, Na, K, and Li; wherein the average thickness of said powder is greater than about 5 nanometers and less than about 10 micrometers.

A cathode active material comprising a powder transition metal hexacyanometalate. Said transition metal hexacyanometalate is at least one transition metal hexacyanometalate with the simplified chemical form A^{va}ₐ(M₁^{v1})_{b}[M₂^{v2}(CN)_{c}]_{d}*xH₂O, where “A” is an insertion cation of valence “va” of an alkali metal, an alkaline earth metal, a proton or ammonium, where “M₁” is a metal ion of valence “v1”, where “M₂” is a metal ion of valence “v2”, where “a”, “b”, “c”, and “d” represent stoichiometry of the complex, and where “x” represents the stoichiometry of coordinated water molecules, where M₁ is at least one element selected from a group consisting of Mn, Ni, Co, Fe, Al, Cr, Mo, V, W, Ta, Pb, Sn, Ti, Cu, Zn, and Nb, where M₂ is least one element selected from a group consisting of Mn, Ni, Co, Fe, Al, Cr, Mo, V, W, Ta, Pb, Sn, Ti, Cu, Zn, and Nb; wherein the average thickness of said powder is greater than about 5 nanometers and less than about 10 micrometers.

A cathode active material comprising one or more transition metal hexacyanometalate with the physical form selected from a group consisting of a powder, a functionalizing deposit layer, and any combination thereof, such metal hexacyanometalate includes at least one material selected from a group consisting of metal hexacyanoferrates, metal hexacyanotitanates, metal hexacyanocobaltates, metal hexacyanomanganates and any combination thereof.

A cathode comprising a functionalized carbon material having a specific surface area greater than about 100 m²/g and less than about 3000 m²/g; having the form of a monolith or a powder composite, the powder composite further comprising a binder and a conductivity enhancing carbon; comprising at least one carbon material selected from a group consisting of porous carbon, carbon microfibers, carbon nanofibers, carbon nanotubes, graphene, reduced graphene oxide, graphite, carbon black, and a carbon material derived from any combination thereof; and further comprising at least one functionalizing agent, the incorporation of said functionalizing agent with said carbon material is one or more selected a group consisting of a dopant, a physical mixture within said carbon matrix, a deposit upon said carbon surface, or any combination thereof. Said dopant comprises at least one P-block element selected from a group consisting of boron (B), N, O, fluorine (F), Si, P, S, chlorine (Cl), Ga, Ge, selenium (Se), bromine (Br), and iodine (I). Said functionalizing agent incorporated as a physical mixture within said carbon matrix comprises at least one inorganic compound containing material A and material B, or a combination of material A, material B and at least one cation species, wherein material A is selected from a group of consisting of Mn, Ni, Co, Fe, Al, Cr, Mo, V, W, Ta, Pb, Sn, Ti, Cu, Zn, Nb, Si, Na, K, Li, and any combination thereof, and material B is selected from a group of consisting of O, H, P, C, N, S and any combination thereof. The surface deposit comprises at least one selected from a group comprising inorganic compound, electro-active polymer, electro-active polymer which is doped with at least one inorganic species, one or more transition metal hexacyanometalate, and any combination thereof. Said inorganic compound deposit contains material A and material B, or a combination of material A, material B and at least one cation species, wherein material A is selected from a group of consisting of Mn, Ni, Co, Fe, Al, Cr, Mo, V, W, Ta, Pb, Sn, Ti, Cu, Zn, Nb, Si, Na, K, Li, and any combination thereof, and material B is selected from a group of consisting of O, H, P, C, N, S and any combination thereof. Said electro-active polymer is selected from a group consisting of PPy, PANI, PEDOT, POMA, PDAAQ, PQ, PIn, CIT, 5-carboxy CIT, 5-cyano CIT, PAC, PA, PVPy, tetramethylpyridine, PT, and derivatives and combinations thereof. The dopant of said electro-active polymer is at least one element selected from a group consisting of O, H, P, C, N, S, Mn, Ni, Co, Fe, Al, Cr, Mo, V, W, Ta, Pb, Sn, Ti, Cu, Zn, Nb, Na, K, Mg, Ca, and Li. Said transition metal hexacyanometalate is at least one transition metal hexacyanometalate with the simplified chemical form A^{va}ₐ(M₁^{v1})_{b}[M₂^{v2}(CN)_{c}]_{d}*xH₂O, where “A” is an insertion cation of valence “va” of an alkali metal, an alkaline earth metal or ammonium, where “M₁” is a metal ion of valence “v1”, where “M₂” is a metal ion of valence “v2”, where “a”, “b”, “c”, and “d” represent stoichiometry of the complex, and where “x” represents the stoichiometry of coordinated water molecules, where M₁ is at least one element selected from a group consisting of Mn, Ni, Co, Fe, Al, Cr, Mo, V, W, Ta, Pb, Sn, Ti, Cu, Zn, and Nb, where M₂ is least one element selected from a group consisting of Mn, Ni, Co, Fe, Al, Cr, Mo, V, W, Ta, Pb, Sn, Ti, Cu, Zn, and Nb. The average thickness of said surface coating is greater than about 5 nanometers and less than about 1000 nanometers.

An integral electrode assembly comprising at least one monolithic electrode and a current collector, wherein the monolithic electrode comprises at least one of the aforementioned polymer-derived carbon, the aforementioned templated carbon, or the aforementioned functionalized carbon; wherein said current collector comprises one or more sheets of graphite foil, or a laminate of two or more sheets of graphite foil with at least one metal layer therebetween and an edge sealant wherein said metal is melted or is partially melted or sintered upon the facing surfaces of said graphite foil sheets and subsequently thereby maintaining mechanical integrity and electrical conductivity of said laminate; and wherein a continuous solid carbon phase exists between the graphite foil and the monolithic carbon electrode material. Said integral electrode assembly finds utility as a cathode/current collector in the aforementioned MIPC or other energy device including electrochemical capacitor, battery, metal air battery, fuel cell, or combinations thereof.

The method for preparing a monolithic cathode is first prepared prior to MIPC assembly, wherein said monolithic carbon cathode comprises the aforementioned templated carbon or the aforementioned polymer-derived carbon, wherein said preparation comprises: a/preparing cathode current collector material selected from a group consisting of one or more sheets of graphite foil, and a laminate of two or more sheets of graphite foil with at least one metal layer therebetween and an edge sealant wherein said metal is melted or is partially melted or is sintered upon the facing surfaces of said graphite foil sheets thereby maintaining mechanical integrity and electrical conductivity of said laminate; b/ preparing the surface of said cathode current collector prior to the application of cathode precursor material for the purpose of removing impurities, oxidation and other passivation inducing products from said surfaces, thereby improving the interfacial resistance and adherence between the cathode and current collector, said preparation is by at least one method selected from a group consisting of heat, mechanical, chemical, sonication, electrochemical, heat application, and combinations thereof; c/ forming a cathode assembly comprising one or more solid monolithic cathode carbon precursor structures upon at least one side of said cathode current collector thereby simultaneously creating carbon monolith precursor structure and bonding the same to said current collector; d/ pyrolizing at a temperature of at least about 500 degrees C. under an inert atmosphere, said cathode assembly comprising one or more carbon monolith precursor structures and said current collector so as to convert said monolithic carbon cathode precursor structures to carbon which is bonded to said current collector; and e/ rinsing said cathode assembly to remove impurities and precursor materials.

The aforementioned MIPC cathode current collector is physically connected and electrically in contact with said cathode; wherein said cathode current collector comprises at least one form selected from a group consisting of foil, laminated foil composite, textured foil, patterned foil, etched foil, perforated foil, honeycomb foil, expanded foil, wire mesh, solid foam structure, polymer-bound foam powder composite, solid structure formed from powder, and polymer-bound powder composite; wherein said cathode current collector comprises at least one material selected from a group consisting of glassy carbon, graphitic carbon, and a solid state material comprising material A or any combination of material A and material B, wherein material A comprises one or more selected from a group consisting of Sn, Ni, Co, Ti, In, Pb, Cr, Fe, Ga, Ta, Zn, Nb, V, Mn, Zr, Al, Mg, Na, Ca, Sr, Ba, K, Li, Cu, and alloys thereof, wherein material B comprises one or more selected from a group consisting of Bi, Ge, Si, O, P, N, Ga, Mo, C, B, S, Sb, and Se.

An example embodiment MIPC wherein a laminate current collector comprises a laminate of two or more sheets of graphite foil with at least one metal or alloy layer therebetween and an edge sealant wherein said metal/alloy is melted or is partially melted or is sintered upon the facing surfaces of said graphite foil sheets thereby bonding the laminate, maintaining mechanical integrity and electrical conductivity of said laminate. Said metal/alloy is selected at least on the basis of its melting point temperature compatibility with said graphite foil in two distinct atmospheres: a/ oxidizing, and b/ non-oxidizing atmosphere. In the case wherein the metal/alloy is melted or partially melted or sintered in an oxidizing (i.e. air) atmosphere, the melting point of said metal/alloy is lower than the highest temperature at which the graphite foil remains stable and not oxidized. Example metal alloys suitable for use in this way includes Mg/Zn alloys, Mg/Ca alloys, Mg/Al alloys, Ca/Al alloys, and Zn/Al family of alloys including ZA8, ZA12 and ZA27. In the case wherein the metal/alloy is melted or partially melted or sintered in non-oxidizing atmosphere, metals or metal alloys with higher melting points may be used. This is particularly true in the case wherein a carbon precursor electrode material is attached to a graphite current collector prior to the conversion of said precursor to carbon by pyrolization. In this case, the heat processing used to pyrolize the carbon precursor is performed in a non-oxidizing atmosphere, and may simultaneously be used to melt or partially melt or sinter said metal/alloy thereby bonding said laminate current collector. Alternatively, a metal/alloy may be selected with a higher melting point temperature versus the carbon pyrolization temperature. In this case, the laminate current collector can be formed prior to carbon pyrolization, again under non-oxidizing atmosphere. Metals or alloys suitable for each of these laminate strategies include elements selected from a group consisting of Zn, Al, Mg, Cu, Fe, Pb, Cd, Sn, Ca, Ni, Co, Ti, In, Cr, Ta, Nb, V, Mn, Zr, Sr, Ba, Ge, As, Se, Sb, Te, and alloys thereof. Said laminate current collector finds utility in the aforementioned MIPC or other energy device including electrochemical capacitor, battery, metal air battery, fuel cell, or combinations thereof. Said laminate current collector also finds utility as a current conductor in any device or application wherein electrical current is conducted.

The method of preparation of said laminate current collector comprises: a/ preparation of the graphite foil surfaces to which the metal/alloy will bond, b/ application of said metal/alloy, c/ bonding of the laminate, and d/ sealing the edges of said laminate. Preparation of said graphite foil surfaces comprises the removal of impurities, oxidation and other passivation inducing products from said surfaces, thereby improving the interfacial resistance and adherence of the laminate graphite foil and metal components. Said graphite foil preparation is by at least one method selected from a group consisting of mechanical, chemical, sonication, electrochemical, heat application, and combinations thereof. The form of said metal/alloy may be a foil, perforated foil, expanded foil, powder, liquid powder suspension, gel powder suspension, molten gel, molten liquid or combinations thereof. If the form of said metal/alloy is a foil, it is physically placed between said graphite foil sheets. If the form of said metal/alloy is a powder, molten gel, or molten liquid, the method of depositing upon the surface of one or both sheets of graphite foil include thermal spray, sputter, dip, and hot roll. If the form of said metal/alloy is a liquid powder suspension, gel powder suspension, or the like, the suspension is applied to the surface of one or both sheets of graphite foil by spray, extrusion, dip coating, doctor blade, rolling or combinations thereof. The application of said metal/alloy to said graphite foil is followed by bonding the laminate of at least two sheets of graphite foil and metal/alloy using a heating process, a pressing process, a rolling process or combinations thereof. The bonding process is followed by the application of a sealant at the edges of said laminate, the purpose of which sealant is to isolate the metal/alloy from contact with electrolyte or other external matter. Said bonding is accomplished with the application of a sealant which type is not particularly limited, including one or more compound selected from a group comprising rubber, silicone, epoxy, polymer, paraffin, carbon, and combinations thereof.

Said MIPC may also include a gas pressure relief valve which will prevent the accumulation of evolved gas or gasses from damaging the MIPC packaging.

An exemplary embodiment of a MIPC comprising a multi-functional electrolyte, an ADS, a cathode, a cathode current collector, a separator function, an anode current collector function, and packaging; wherein the multifunctional electrolyte comprises cation M=Zn²⁺, and cation C=one or more of cation species of Pb, In, Bi, Ni, Li, Na, K, Mg, Ca, hydronium and ammonium; wherein the multifunctional electrolyte further comprises anion species elected from a group consisting of Cl⁻, SO₄²⁻, NO₃⁻, OH⁻, TFSI⁻, FSI⁻, PF₆⁻, CF₃SO₃⁻, CH₃SO₃⁻, BOB⁻, FAP⁻, BF₄⁻, ClO₄⁻, AsF₆⁻, Br⁻; I⁻, BETI⁻, DCTA⁻, TDI⁻, AlCl₄⁻, SbF₆⁻, SCN⁻, CF₃CO₂⁻, (CF₃SO₂)₂⁻, N(CF₃SO₂)₂⁻, NTf₂⁻, and B(C₆H₅)₄⁻, and combinations thereof; wherein the composition of said multi-functional electrolyte is selected from a group consisting of ionic liquid, salt and liquid solvent, salt and gel solvent, salt and solid state ion conductor, and combinations thereof; the liquid solvent is at least one selected from a group consisting of water and organic liquid; the organic liquid solvent is at least one selected from a group consisting of EC, FEC, PC, DEC, DE, DME, EMC, DMC, EG, DGD, DGDE, DEBD, DPGDME, DEE, BEE, TMS, FMS, DMSO, AN, THF, 2-Me THF, MF, GBL, AND, SCN, GLN, PMN, SUN, SEN, MFE, TMMP, TPTP, and TTFP; the multifunctional electrolyte employing a liquid water solvent possesses pH above about 2 and below about 7; the ionic liquid is at least one selected from a group consisting of EMITFSI, EMIBF₄, EMIM OTf, EMIM BTA, PMPyrr BTA, EMIM-NTf₂, PYR₁₃TFSI, 1-allyl-3-methylimidazolium tetrachloroaluminate, 1-(3-cyanopropyl) pyridinium tetrachloroaluminate, 1-butyl-1-methylpyrrolidinium tetraaluminate, 1,2,4-trimethylpyrazolium tetraaluminate, and triphenylmethylphosphonium tetraaluminate; the multi-functional electrolyte gel or solid component is at least one selected from a group consisting of PMMA, PVA, PSO, PEO, PSU, PMEO, PI, PA, PET, PP, PEN, PEG, PC, PAN, PPS, PTFE, PVDF, PAAK, PAAM, fumed silica, and cellulose; wherein the ADS comprises electrochemically active surfaces and electrochemically inactive surfaces, and further comprises at least one material selected from a group consisting of glassy carbon, graphitic carbon, solid state metal of Zn or an alloy thereof; the ADS form is selected from a group consisting of foil, foil with spacers, honeycomb foil, honeycomb foil with electrochemically inactive surfaces coated with a barrier layer, textured foil, patterned foil, patterned foil with barrier coating, etched foil, etched foil with spacers, perforated foil, perforated foil with electrochemically inactive surfaces coated with a barrier layer, expanded foil, expanded foil with electrochemically inactive surfaces coated with a barrier layer, wire mesh, solid foam structure, solid foam structure with electrochemically inactive surfaces coated with a barrier layer, polymer-bound foam powder composite, solid structure formed from sintered, partially melted or melted powder, and polymer-bound powder composite; the barrier coating and spacer coating comprise at least one layer of at least one material selected from a group consisting of inorganic material, ceramic material, organic material, epoxy, plastic, nylon, and polymer; wherein the anode current collector function comprises a/ the aforementioned ADS, or b/ a current collector which is separate from the aforementioned ADS, said separate anode current collector is physically and electrically in contact with said ADS; wherein the mechanical form of said separate anode current collector is one or any combination of forms selected from a group consisting of foil, textured foil, patterned foil, etched foil, perforated foil, honeycomb foil, expanded foil, a layered laminate, wire mesh, solid foam structure, polymer-bound foam powder composite, solid structure formed from sintered or melted powder, and polymer-bound powder composite; wherein said separate anode current collector comprises at least one material selected from a group consisting of glassy carbon, graphitic carbon, and a solid state material comprising material A or any combination of material A and material B, wherein material A comprises one or more selected from a group consisting of Sn, Ni, Co, Ti, In, Pb, Cr, Fe, Ga, Ta, Zn, Nb, V, Mn, Zr, Al, Mg, Na, Ca, Sr, Ba, K, Li, Cu, and alloys thereof, wherein material B comprises one or more selected from a group consisting of Bi, Ge, Si, O, P, N, Ga, Mo, C, B, S, Sb, and Se; the cathode form is a composite or a monolith; cathode active material comprises a powder transition metal hexacyanometalate, a high surface area carbon, or a high surface area carbon possessing functionalizing materials selected from a group consisting of N, O, B, P, S, surface deposit of transition metal hexacyanometalate, surface deposit of doped electroactive polymer, surface deposit of transition metal oxide, transition metal oxide within said carbon matrix, and combinations thereof; said transition metal hexacyanometalate is at least one selected from a group consisting of copper hexacyanoferrate ACuFe(CN)₆, nickel hexacyanoferrate ANiFe(CN)₆, or any combination thereof, wherein Fe is reduced from 3⁺ to 2⁺ valence upon insertion of cation A⁺; said high surface area carbon is at least one selected from a group consisting of polymer-derived carbon, carbide-derived carbon, activated cellulose-derived carbon, templated carbon, carbon microfibers, carbon nanofibers, carbon nanotubes, graphene, reduced graphene oxide, graphite, carbon black, and a carbon material derived from any combination thereof; wherein the cathode current collector comprises graphite foil or a laminate comprising graphite foil and metal; wherein the separator function is performed by one or more selected from a group consisting of the aforementioned ADS barrier coating, an ADS spacer coating, a solid electrolyte, a gel electrolyte, and a porous separator sheet; said porous separator sheet is at least one material selected from a group consisting of PET, PP, PEN, PC, PPS, PTFE, PVDF, cellulose fiber, glass fiber, and absorbed glass mat; and wherein the packaging features are selected from a group consisting of spiral wound MIPC in a cylinder, a prismatic MIPC in a pouch, a dip-coat comprising plastic or epoxy, a bipolar stack, plastic casing, metal casing, carbon fiber casing, electrical terminals, a pressure relief valve, and combinations thereof.

In the MIPC case wherein the multifunctional electrolyte an aqueous solution wherein M is a zinc cation and a chloride anion is used, the possibility of generating H₂ and Cl₂ gas exists. Ultra-violet light catalyses the reaction of H₂ and Cl₂ to form HCl gas, which is readily absorbed by the aqueous electrolyte. In an embodiment of such as MIPC, a means of exposing said gasses within an MIPC cell to UV light is incorporated into the MIPC. Such a means includes a/ a material suitable for conducting UV light into the MIPC from an external source, providing an integral UV light source, or combinations thereof. Examples of said UV light conductors includes glass, quartz, plastic, polymer, polycarbonate etc. An example of an integral UV light source is a UV light emitting diode (UV LED). The UV light should be pulsed in a timely manner so as to minimize the gas accumulation.

An example embodiment wherein the ADS comprises at least zinc metal and M comprises at least a zinc salt in an aqueous electrolyte, wherein the ADS, the electrolyte or both are modified to suppress H₂ evolution occurring at the ADS. Said modification includes the addition of elements selected from a group consisting of Bi, In, Al, Pb, and combinations thereof to said ADS as alloying materials, as coatings, or any combination thereof applied to the ADS material prior to cell assembly, in-situ from an electrolyte additive salt, or by both methods. Said additional elements may also include elements, salts or both selected from a group consisting of Sn, Ni, Co, Ti, Cr, Fe, Ga, Ta, Nb, V, Mn, Zr, Al, Mg, Na, Ca, Sr, Ba, K, Li, Cu, Ge, Si, O, P, N, Ga, In, Mo, C, B, S, Sb, Se and combinations thereof.

Another example embodiment of an MIPC includes electrolyte additives to improve quality of metal deposits upon ADS, said additives comprise one or more organic compound, one or more inorganic compound, or combinations thereof.

An exemplary embodiment of a MIPC comprising a multi-functional electrolyte, an ADS, a cathode, a cathode current collector, a separator function, an anode current collector function, and packaging; wherein the multifunctional electrolyte comprises cation M selected from a group consisting of cation species of Li, Al, Mg, Ca, Na, K, and combinations thereof; wherein the multifunctional electrolyte further comprises anion species elected from a group consisting of Cl⁻, SO₄²⁻, NO₃⁻, OH⁻, TFSI⁻, FSI⁻, PF₆⁻, CF₃SO₃⁻, CH₃SO₃⁻, BOB⁻, FAP⁻, BF₄⁻, ClO₄⁻, AsF₆⁻, Br⁻; I⁻, BETI⁻, DCTA⁻, TDI⁻, AlCl₄⁻, SbF₆⁻, SCN⁻, CF₃CO₂⁻, (CF₃SO₂)₂⁻, N(CF₃SO₂)₂⁻, NTf₂⁻, and B(C₆H₅)₄⁻, and combinations thereof; wherein the composition of said multi-functional electrolyte is selected from a group consisting of ionic liquid, salt and liquid solvent, salt and gel solvent, salt and solid state ion conductor, and combinations thereof; the liquid solvent is at least one selected from a group consisting of water and organic liquid; the organic liquid solvent is at least one selected from a group consisting of EC, FEC, PC, DEC, DE, DME, EMC, DMC, EG, DGD, DGDE, DEBD, DPGDME, DEE, BEE, TMS, FMS, DMSO, AN, THF, 2-Me THF, MF, GBL, AND, SCN, GLN, PMN, SUN, SEN, MFE, TMMP, TPTP, and TTFP; the ionic liquid is at least one selected from a group consisting of EMITFSI, EMIBF₄, EMIM OTf, EMIM BTA, PMPyrr BTA, EMIM-NTf₂, PYR₁₃TFSI, 1-allyl-3-methylimidazolium tetrachloroaluminate, 1-(3-cyanopropyl) pyridinium tetrachloroaluminate, 1-butyl-1-methylpyrrolidinium tetraaluminate, 1,2,4-trimethylpyrazolium tetraaluminate, and triphenylmethylphosphonium tetraaluminate; the multi-functional electrolyte gel or solid component is at least one selected from a group consisting of PMMA, PVA, PSO, PEO, PSU, PMEO, PI, PA, PET, PP, PEN, PEG, PC, PAN, PPS, PTFE, PVDF, PAAK, PAAM, fumed silica, and cellulose; wherein the ADS comprises electrochemically active surfaces or electrochemically active surfaces and electrochemically inactive surfaces, and further comprises at least one material selected from a group consisting of glassy carbon, graphitic carbon, solid state metal of M or alloy of M, and a solid state material comprises material A or any combination of material A and material B, wherein material A comprises one or more selected from a group consisting of Sn, Ni, Co, Ti, In, Pb, Cr, Fe, Ga, Ta, Zn, Nb, V, Mn, Zr, Al, Mg, Na, Ca, Sr, Ba, K, Li, Cu, and alloys thereof, wherein material B comprises one or more selected from a group consisting of Bi, Ge, Si, O, P, N, Ga, Mo, C, B, S, Sb, and Se; the ADS form is selected from a group consisting of foil, foil with spacers, honeycomb foil, honeycomb foil with electrochemically inactive surfaces coated with a barrier layer, textured foil, patterned foil, patterned foil with barrier coating, etched foil, etched foil with spacers, perforated foil, perforated foil with electrochemically inactive surfaces coated with a barrier layer, expanded foil, expanded foil with electrochemically inactive surfaces coated with a barrier layer, wire mesh, solid foam structure, solid foam structure with electrochemically inactive surfaces coated with a barrier layer, polymer-bound foam powder composite, solid structure formed from sintered, partially melted or melted powder, and polymer-bound powder composite; the barrier coating and spacer coating comprise at least one layer of at least one material selected from a group consisting of inorganic material, ceramic material, organic material, epoxy, plastic, nylon, and polymer; wherein the anode current collector function comprises a/ the aforementioned ADS, or b/ a current collector which is separate from the aforementioned ADS, said separate anode current collector is physically and electrically in contact with said ADS; wherein the mechanical form of said separate anode current collector is one or any combination of forms selected from a group consisting of foil, textured foil, patterned foil, etched foil, perforated foil, honeycomb foil, expanded foil, a layered laminate, wire mesh, solid foam structure, polymer-bound foam powder composite, solid structure formed from sintered or melted powder, and polymer-bound powder composite; wherein said separate anode current collector comprises at least one material selected from a group consisting of glassy carbon, graphitic carbon, and a solid state material comprising material A or any combination of material A and material B, wherein material A comprises one or more selected from a group consisting of Sn, Ni, Co, Ti, In, Pb, Cr, Fe, Ga, Ta, Zn, Nb, V, Mn, Zr, Al, Mg, Na, Ca, Sr, Ba, K, Li, Cu, and alloys thereof, wherein material B comprises one or more selected from a group consisting of Bi, Ge, Si, O, P, N, Ga, Mo, C, B, S, Sb, and Se; wherein the separator function is performed by one or more selected from a group consisting of the aforementioned ADS barrier coating, an ADS spacer coating, a solid electrolyte, a gel electrolyte, and a porous separator sheet; said porous separator sheet is at least one material selected from a group consisting of PET, PP, PEN, PC, PPS, PTFE, PVDF, cellulose fiber, glass fiber, and absorbed glass mat; and wherein the packaging features are selected from a group consisting of spiral wound MIPC in a cylinder, a prismatic MIPC in a pouch, a dip-coat comprising plastic or epoxy, a bipolar stack, plastic casing, metal casing, carbon fiber casing, electrical terminals, a pressure relief valve, and combinations thereof; wherein the cathode form is a composite or a monolith; cathode active material comprises one or more from a group consisting of one or more transition metal hexacyanometalate, one or more electroactive polymer, one or more doped electroactive polymer, one or more high surface area carbon, or a high surface area carbon possessing functionalizing materials selected from a group consisting of dopants N, O, B, P, S, or a surface deposit of one or more doped electroactive polymer, surface deposit of one or more transition metal oxide, surface deposit of one or more transition metal hexacyanometalate, one or more transition metal oxide within said carbon matrix, and combinations thereof; said high surface area carbon is at least one selected from a group consisting of polymer-derived carbon, carbide-derived carbon, activated cellulose-derived carbon, templated carbon, carbon microfibers, carbon nanofibers, carbon nanotubes, graphene, reduced graphene oxide, graphite, carbon black, and a carbon material derived from any combination thereof; wherein said cathode current collector comprises at least one form selected from a group consisting of foil, laminated foil composite, textured foil, patterned foil, etched foil, perforated foil, honeycomb foil, expanded foil, wire mesh, solid foam structure, polymer-bound foam powder composite, solid structure formed from powder, and polymer-bound powder composite; wherein said cathode current collector material is at least one selected from a group consisting of glassy carbon, graphitic carbon, and a solid state material comprising material A or any combination of material A and material B, wherein material A comprises one or more selected from a group consisting of Sn, Ni, Co, Ti, In, Pb, Cr, Fe, Ga, Ta, Zn, Nb, V, Mn, Zr, Al, Mg, Na, Ca, Sr, Ba, K, Li, Cu, and alloys thereof, wherein material B comprises one or more selected from a group consisting of Bi, Ge, Si, O, P, N, Ga, Mo, C, B, S, Sb, and Se. The MIPC exemplary embodiment wherein said cathode current collector wherein the current collector material comprises a metal, graphite foil, or a laminate of said metal with graphite foil, wherein said metal is Al or an alloy of Al with one or more of Cu, Mg, Li and Ca. The MIPC exemplary embodiment wherein said ADS material selected from a group consisting of Cu, Al, Li, Ca, Mg and alloys thereof. Said transition metal hexacyanometalate includes at least one material selected from a group consisting of metal hexacyanoferrates, metal hexacyanotitanates, metal hexacyanocobaltates, metal hexacyanomanganates, manganese hexacyanoferrate, copper hexacyanoferrate, nickel hexacyanoferrate, tetraethyl ammonium hexacyanomanganate, and any combination thereof.

An exemplary embodiment of a MIPC comprising a multi-functional electrolyte, an ADS, a cathode, a cathode current collector, a separator function, an anode current collector function, and packaging; wherein the multifunctional electrolyte comprises cation M=Pb²⁺, and cation C=one or more of cation species of Zn, In, Bi, Ni, Li, Na, K, Mg, Ca, H, hydronium, and ammonium; wherein the multifunctional electrolyte further comprises anion species elected from a group consisting of Cl⁻, SO₄²⁻, NO₃⁻, OH⁻, TFSI⁻, FSI⁻, PF₆⁻, CF₃SO₃⁻, CH₃SO₃⁻, BOB⁻, FAP⁻, BF₄⁻, ClO₄⁻, AsF₆⁻, Br⁻; I⁻, BETI⁻, DCTA⁻, TDI⁻, AlCl₄⁻, SbF₆⁻, SCN⁻, CF₃CO₂⁻, (CF₃SO₂)₂⁻, N(CF₃SO₂)₂⁻, NTf₂⁻, and B(C₆H₅)₄⁻, and combinations thereof; wherein the composition of said multi-functional electrolyte is selected from a group consisting of ionic liquid, salt and liquid solvent, salt and gel solvent, salt and solid state ion conductor, and combinations thereof; the liquid solvent is at least one selected from a group consisting of water and organic liquid; the organic liquid solvent is at least one selected from a group consisting of EC, FEC, PC, DEC, DE, DME, EMC, DMC, EG, DGD, DGDE, DEBD, DPGDME, DEE, BEE, TMS, FMS, DMSO, AN, THF, 2-Me THF, MF, GBL, AND, SCN, GLN, PMN, SUN, SEN, MFE, TMMP, TPTP, and TTFP; the multifunctional electrolyte employing a liquid water solvent possesses pH above about 0.5 and below about 6; the ionic liquid is at least one selected from a group consisting of EMITFSI, EMIBF₄, EMIM OTf, EMIM BTA, PMPyrr BTA, EMIM-NTf₂, PYR₁₃TFSI, 1-allyl-3-methylimidazolium tetrachloroaluminate, 1-(3-cyanopropyl)pyridinium tetrachloroaluminate, 1-butyl-1-methylpyrrolidinium tetraaluminate, 1,2,4-trimethylpyrazolium tetraaluminate, and triphenylmethylphosphonium tetraaluminate; the multi-functional electrolyte gel or solid component is at least one selected from a group consisting of PMMA, PVA, PSO, PEO, PSU, PMEO, PI, PA, PET, PP, PEN, PEG, PC, PAN, PPS, PTFE, PVDF, PAAK, PAAM, fumed silica, and cellulose; wherein the ADS comprises electrochemically active surfaces and electrochemically inactive surfaces, and further comprises at least one material selected from a group consisting of glassy carbon, graphitic carbon, solid state metal of Pb or an alloy thereof; the ADS form is selected from a group consisting of foil, foil with spacers, honeycomb foil, honeycomb foil with electrochemically inactive surfaces coated with a barrier layer, textured foil, patterned foil, patterned foil with barrier coating, etched foil, etched foil with spacers, perforated foil, perforated foil with electrochemically inactive surfaces coated with a barrier layer, expanded foil, expanded foil with electrochemically inactive surfaces coated with a barrier layer, wire mesh, solid foam structure, solid foam structure with electrochemically inactive surfaces coated with a barrier layer, polymer-bound foam powder composite, solid structure formed from sintered, partially melted or melted powder, and polymer-bound powder composite; the barrier coating and spacer coating comprise at least one layer of at least one material selected from a group consisting of inorganic material, ceramic material, organic material, epoxy, plastic, nylon, and polymer; wherein the anode current collector function comprises a/ the aforementioned ADS, or b/ a current collector which is separate from the aforementioned ADS, said separate anode current collector is physically and electrically in contact with said ADS; wherein the mechanical form of said separate anode current collector is one or any combination of forms selected from a group consisting of foil, textured foil, patterned foil, etched foil, perforated foil, honeycomb foil, expanded foil, a layered laminate, wire mesh, solid foam structure, polymer-bound foam powder composite, solid structure formed from sintered or melted powder, and polymer-bound powder composite; wherein said separate anode current collector comprises at least one material selected from a group consisting of glassy carbon, graphitic carbon, and a solid state material comprising material A or any combination of material A and material B, wherein material A comprises one or more selected from a group consisting of Sn, Ni, Co, Ti, In, Pb, Cr, Fe, Ga, Ta, Zn, Nb, V, Mn, Zr, Al, Mg, Na, Ca, Sr, Ba, K, Li, Cu, and alloys thereof, wherein material B comprises one or more selected from a group consisting of Bi, Ge, Si, O, P, N, Ga, Mo, C, B, S, Sb, and Se; the cathode form is a composite or a monolith; cathode active material comprises a transition metal hexacyanometalate, a high surface area carbon, or a high surface area carbon possessing functionalizing materials selected from a group consisting of N, O, B, P, S, surface deposit of transition metal hexacyanometalate, surface deposit of doped electroactive polymer, surface deposit of transition metal oxide, transition metal oxide within said carbon matrix, and combinations thereof; said transition metal hexacyanometalate is at least one selected from a group consisting of copper hexacyanoferrate ACuFe(CN)₆, nickel hexacyanoferrate ANiFe(CN)₆, or any combination thereof, wherein Fe is reduced from 3⁺ to 2⁺ valence upon insertion of cation A⁺; said high surface area carbon is at least one selected from a group consisting of polymer-derived carbon, carbide-derived carbon, activated cellulose-derived carbon, templated carbon, carbon microfibers, carbon nanofibers, carbon nanotubes, graphene, reduced graphene oxide, graphite, carbon black, and a carbon material derived from any combination thereof; wherein the cathode current collector comprises graphite foil or a laminate comprising graphite foil and metal; wherein the separator function is performed by one or more selected from a group consisting of the aforementioned ADS barrier coating, an ADS spacer coating, a solid electrolyte, a gel electrolyte, and a porous separator sheet; said porous separator sheet is at least one material selected from a group consisting of PET, PP, PEN, PC, PPS, PTFE, PVDF, cellulose fiber, glass fiber, and absorbed glass mat; and wherein the packaging features are selected from a group consisting of spiral wound MIPC in a cylinder, a prismatic MIPC in a pouch, a dip-coat comprising plastic or epoxy, a bipolar stack, plastic casing, metal casing, carbon fiber casing, electrical terminals, a pressure relief valve, and combinations thereof.

An exemplary embodiment of a MIPC wherein M=lead (Pb); C=one or more of In, Bi, Li, Na, K, Mg, Ca, H, hydronium, and ammonium; ADS comprises Pb or an alloy thereof; ADS form is a honeycomb foil or a honeycomb foil with electrochemically inactive surfaces coated with a barrier layer; cathode form is a composite or a monolith; cathode active material comprises a high surface area carbon, or a high surface area carbon possessing functionalizing materials selected from a group consisting of N, O, B, P, S, surface deposit of doped electroactive polymer, surface deposit of lead oxide, lead oxide within said carbon matrix, and combinations thereof; cathode current collector comprises graphite foil or a laminate comprising graphite foil and metal; and separator comprises the aforementioned ADS barrier coating, absorbed glass mat, or combinations thereof. Multifunctional electrolyte system comprises at least one aqueous electrolyte selected from a group consisting of H₂SO₄, HCL, PbSO₄, PbCl₂, Li₂SO₄, LiCl, Na₂SO₄, NaCl, K₂SO₄, KCL, MgSO₄, MgCl₂, CaSO₄, CaCl₂, as a liquid, a gel, a solid, or any combination thereof.

An exemplary embodiment of a MIPC wherein M=H⁺; C=one or more of In, Bi, Li, Na, K, Mg, Ca, H, hydronium, and ammonium; the ADS comprises Pb or an alloy thereof; ADS form is one or any combination of forms selected from a group consisting of foil, textured foil, patterned foil, etched foil, perforated foil, honeycomb foil, expanded foil, a layered laminate, wire mesh, solid foam structure, polymer-bound foam powder composite, solid structure formed from sintered or melted powder, and polymer-bound powder composite; the ADS comprises electrochemically active surfaces or electrochemically active surfaces and electrochemically inactive surfaces; the cathode form is a composite or a monolith; cathode active material comprises a transition metal hexacyanometalate, a high surface area carbon, or a high surface area carbon possessing functionalizing materials selected from a group consisting of N, O, B, P, S, surface deposit of transition metal hexacyanometalate, surface deposit of doped electroactive polymer, surface deposit of lead oxide, lead oxide within said carbon matrix, and combinations thereof; cathode current collector comprises graphite foil or a laminate comprising graphite foil and metal; and separator comprises the aforementioned ADS barrier coating, absorbed glass mat, electrolyte gel, or combinations thereof. Multifunctional electrolyte system comprises at least one aqueous electrolyte selected from a group consisting of H₂SO₄, HCL, PbSO₄, PbCl₂, Li₂SO₄, LiCl, Na₂SO₄, NaCl, K₂SO₄, KCL, MgSO₄, MgCl₂, CaSO₄, CaCl₂, as a liquid, a gel, a solid, or any combination thereof.

### Example 1

An exemplary embodiment of a MIPC wherein M=Zinc (Zn), anode deposition substrate principally comprises Zn, cathode active material principally comprises a nitrogen doped high surface area carbon, cathode current collector comprises graphite foil, and the multifunctional electrolyte comprises a weakly acidic aqueous ZnCl₂/NaCl about pH 3.5.

Zn and carbon are convenient choices for energy storage materials due to their low toxicity, abundance, low cost and familiarity by the battery manufacturing community.

The electro-deposition/dissolution of zinc metal (i.e. Zn/Zn²⁺) occurs at a nominal (standard) redox potential of approximately −0.76V with respect to standard hydrogen electrode (SHE). This potential represents the potential of Zn in a quiescent state (i.e. absent externally applied current), also referred to as the equilibrium potential. During charge processes, the reaction shifts to more negative potentials versus the equilibrium potential and to more positive potentials during discharge. This is demonstrated in FIG. 12, and is a function of applied current normalized to the reaction area; therefore, within a particular potential range, anode deposition substrates with larger usable surface area will allow larger cell current densities.

In the exemplary embodiment, the multi-functional electrolyte comprised ZnCl₂ and NaCl in water, and the MIPC was examined with this electrolyte at various concentrations ranging between about 1.5 mol/l and 4.5 mol/l for each of the salts, and at various pH ranging between about 2 and about 7 adjusted using HCL and NaOH. In the case of the cell data in exemplary embodiment, the multi-functional electrolyte comprised about 3.5 mol/l ZnCl₂ and about 2.5 mol/l NaCl in water at pH of about 3.5. As can be seen in FIG. 12, the Zn² cation is reduced on the surface of the anode deposition substrate at a potential of about −0.88V vs. Ag/AgCl (3 mol/l) reference during charge, which is equivalent to about −0.67V versus SHE, which represents the under-potential deposition mode for Zn because this potential is below Zn standard redox potential of −0.76V versus SHE. Even at a deposition current of about 10 mA, the ADS potential of FIG. 12 was about −0.93V versus Ag/AgCl, equivalent to −0.72V versus SHE, remaining as an underpotential deposition process. During discharge, dissolution begins at a potential of about −0.89V vs. Ag/AgCl, indicating a charge/discharge hysteresis of about 10 mV and an equilibrium potential of about −0.885V vs. Ag/AgCl. These values for charge, discharge and equilibrium correspond to −0.67V, −0.68V and −0.675V vs. SHE respectively. During the testing performed and the data provided herein, the exemplary embodiment undergoes an under-potential deposition process at current densities up to about −20 mA/cm².

In the exemplary embodiment, the anode deposition substrate comprises at least zinc metal, having an over-potential to HER of about 700 mV which is equivalent to HER onset at about −907 mV versus SHE at pH of about 3.5. Said HER over-potential is increased by forming an alloy with Zn and at least one other element selected from a group consisting of Sn, Ni, Co, Ti, In, Pb, Cr, Fe, Ga, Ta, Nb, V, Mn, Zr, Al, Mg, Na, Ca, Sr, Ba, K, Li, Cu, Bi, Ge, Si, O, P, N, Ga, Mo, C, B, S, Sb, and Se. Said alloying is performed prior to the fabrication of the ADS, during cell operation, or both. Forming the alloy with Zn during cell operation is accomplished by employing electrolyte additives as salts of the other alloying metal.

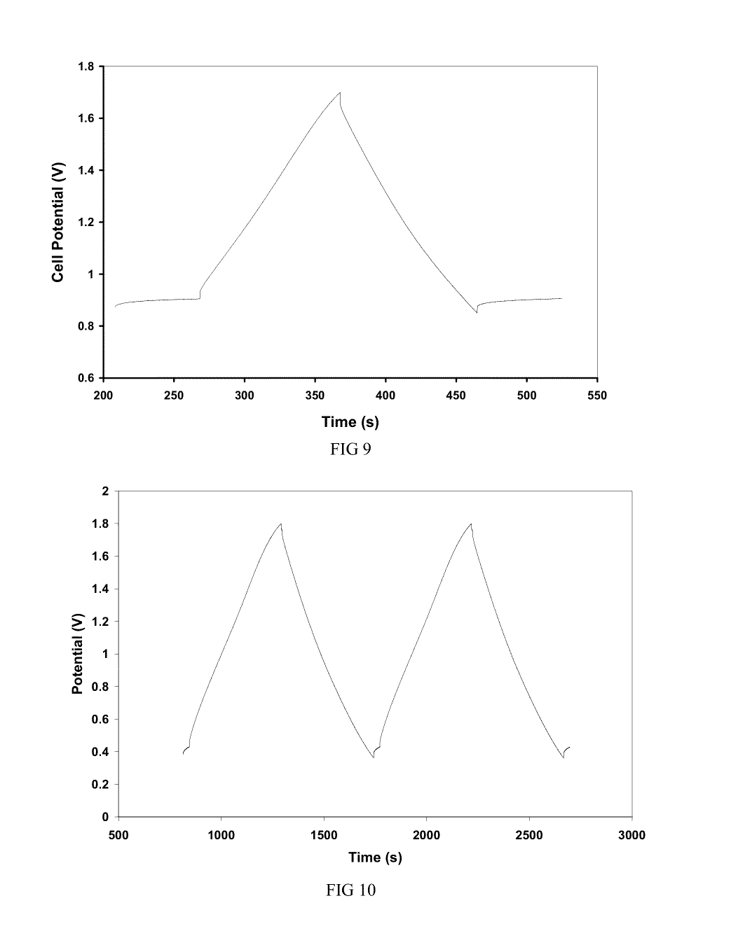

The Zn/Zn²⁺ redox provides a high specific capacity of 820 mAh/g, approximately 20-fold versus that provided by the carbon cathode of the MIPC. As such, the MIPC cell capacitance approaches that of the carbon cathode. In the exemplary embodiment of FIG. 10, the specific capacitance of the cell as normalized to the combined mass of the cathode and deposited Zn anode is approximately 155 F/g. The specific capacitance of the cathode alone in this case was 164 F/g.

The use of Zn as an anode deposition substrate in the exemplary embodiment provides a surface with a consistent deposition work function, thus promoting a uniform layer of Zn metal deposited during the charge process.

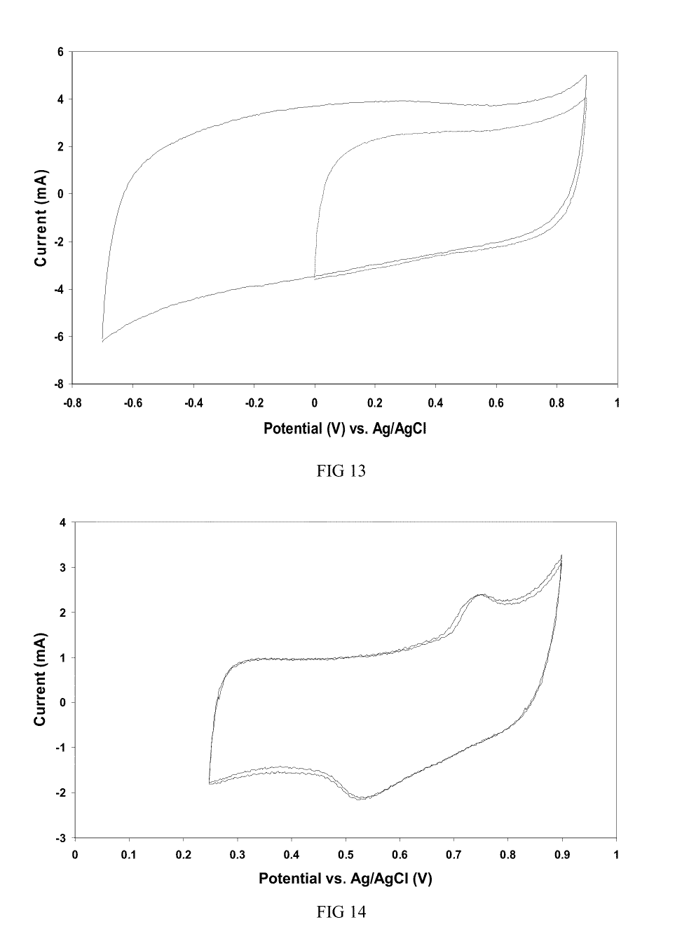

FIG. 13 illustrates cyclic voltammetry of the carbon cathode materials used in the exemplary embodiment, scanned from 0 mV to 900 mV and −700 mV to +900 mV, both versus Ag/AgCl reference. The former scan range corresponds to the potential range used by the cathode as the exemplary embodiment Zn/C MIPC cell of FIG. 11 is scanned between 0.9V and 1.8V. The latter scan of −700 mV to +900 mV correlates to the exemplary embodiment Zn/C MIPC cell charged to 1.8V and discharged to 0.2V.

In the exemplary embodiment, the Cl⁻ anion is adsorbed/desorbed on the surface of the cathode carbon during charge and discharge respectively, at potentials above open circuit of the carbon. At potentials below the cathode open circuit potential, cations H⁺, Na⁺ and Zn²⁺ in the exemplary case, are adsorbed and desorbed during discharge and charge respectively. These processes are generally described as: (B⁻)_{ad}/C⁺+A⁺ [symbol] B⁻+(A⁺)_{ad}/C⁻+xe⁻ wherein (B⁻)_{ad}/C⁺ refers to an anion B adsorbed in the double layer on the positively charged surface of cathode carbon C, and (A⁺)_{ad}/C⁻ refers to cation A similarly adsorbed when the cathode is negatively charged below open circuit potential. If subjected to deep discharge, there is an additional pseudo-capacitive contribution on the carbon electrode by reversible hydrogen adsorption, which is controlled by the value of the of cut-off potential. The reversible hydrogen adsorption can be described by the following: H₂O+e⁻ [symbol] +OH⁻ where [symbol] stands for nascent hydrogen. These processes are evident in the cyclic voltammetry of FIG. 13.

In the exemplary embodiment, HCl and NaOH were used to modify the electrolyte pH so as to be high enough to suppress HER yet also low enough so as to avoid the formation or deposition of Zn(OH)₂, ZnO and Zn₅(OH)₆CO₃. This is done to inhibit the anode passivation commonly found in alkaline Zn systems that are based upon the reaction Zn(OH)₄²⁻+2e⁻ [symbol] Zn+4 OH⁻, for example. Instead, the MIPC of the exemplary embodiment relies on the favorably reversible anode reaction: Zn²⁺+2e⁻ [symbol] Zn.

Fabrication of the Exemplary Embodiment

In the exemplary embodiment, the cathode carbon was a nitrogen-doped carbon xerogel as a carbon microfiber supported monolith attached to a graphite foil current collector as described herein as a unitary or integral electrode/current collector with a continuous C phase. Multifunctional electrolyte comprised purified water, zinc chloride ACS 97% and sodium chloride ACS 99% from supplier Alfa Aesar. Laboratory filter paper number 494 from supplier VWR was used as received as a separator. Zinc metal foil 99.98% from supplier Alfa Aesar was used for the unitary anode deposition substrate/anode current collector. The Zn foil underwent chemical cleaning, mechanical polishing and rolling prior to use within the MIPC cell. Polypropylene pouch material was used as packaging, heat-sealed.

Characterization of Exemplary Embodiment

Characterization of the exemplary embodiment of a MIPC by galvanostatic charge/discharge cycling and cyclic voltammetry of a cell and the anode deposition/dissolution function. FIGS. 9-12 illustrate electrochemical charge storage behavior of MIPC embodiment which utilizes a zinc-based anode function, a combined adsorption/faradaic cathode function and a weakly acidic aqueous electrolyte comprising chlorides of zinc and sodium described above.

FIG. 9 depicts a charge cycle followed by a discharge cycle exhibiting capacitor-like behavior of an example MIPC. In this case, the MIPC cell was charged and discharged between 0.85V to 1.7V at a constant current of 7 mA. Capacitor-like behavior displayed in this Figure includes potential/charge proportionality, rate symmetry, rapid charge/discharge rates and excellent energy efficiency.

A MIPC cell of the same type was made by the inventors and has exhibited excellent charge/discharge cycle life when repeatedly charged to 1.6V and discharged to 0.8V for 33,000 iterations without failure or significant change in capacitance or resistance, and coulombic efficiency remained above about 99%. In this case, the number of completed charge/discharge cycles were limited by available test time and not by the MIPC itself.

FIG. 10 depicts two charge/discharge cycles exhibiting capacitor-like behavior of an example MIPC. In this case, the MIPC cell was charged and discharged between 0.36V and 1.8V using a constant current.

FIG. 11 depicts a charge and discharge cycle exhibiting capacitor-like behavior of an example MIPC. In this case, the MIPC cell was charged and discharged between 0.9V and 1.8V using cyclic voltammetry at a scan rate of 10 mv/S.

FIG. 12 depicts a charge and discharge cycle of a zinc metal foil anode deposition substrate/current collector in an aqueous electrolyte comprising chlorides of zinc and sodium. In this case, the anode functionality was demonstrated using cyclic voltammetry at potentials between −0.945V and −0.845V versus Ag/AgCl reference electrode at a scan rate of 1 mv/S.

### Example 2

Another exemplary embodiment of a MIPC wherein M=Zn, anode deposition substrate principally comprises Zn, cathode active material principally comprises a carbon functionalized by a conformal coating of manganese oxide, cathode current collector comprises graphite foil, and the multifunctional electrolyte comprises a weakly acidic aqueous ZnCl₂/NaCl about 3.5 mol/l ZnCl₂ and about 2.5 mol/1 NaCl in water.

In this embodiment, electro-deposition/dissolution of zinc metal (i.e. Zn/Zn²⁺) at the anode deposition substrate comprises the anode charge storage functionality, and cathode charge storage occurs through cation extraction/insertion during charge and discharge respectively. In this embodiment, cation species inserted and extracted at the cathode may be one or more of Na⁺, Zn²⁺ and H⁺. The present embodiment is not limited either by cation species, anion species or electrolyte solvent; thus other related embodiments are contemplated herein.

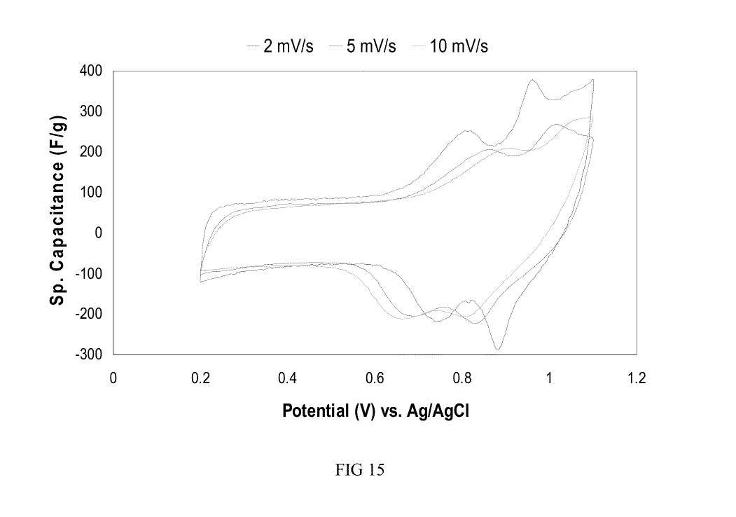

In this embodiment, the manganese oxide versus carbon/oxide loading at the cathode equals about 50%. The average thickness of said manganese oxide coating is about 30 nm. The carbon which is coated by the manganese oxide is a polymer-derived xerogel/microfiber carbon solid mixture. The phase of the manganese oxide in the MIPC cathode embodiment exemplified in FIG. 14 is mostly alpha-phase and the phase of manganese oxide in the MIPC cathode embodiment exemplified in FIG. 15 is mostly spinel phase; however, said functionalization coating is not limited either by element or by phase. As such, manganese oxide phases contemplated herein include spinel, birnessite, cryptomelane, ramsdellite, todorokite, pyrolusite, Na_{0.44}MnO₂, MnOOH, and mixtures thereof.

FIG. 14 depicts charge and discharge cycles of another MIPC cathode embodiment. In this case, a manganese oxide nanofilm cathode of generally alpha phase was charged and discharged between 0.25V and 0.90V versus Ag/AgCl reference electrode using cyclic voltammetry in an aqueous electrolyte comprising chlorides of zinc and sodium.

FIG. 15 depicts charge and discharge cycles of another MIPC cathode embodiment. In this case, a cation doped manganese oxide nanofilm cathode of generally spinel phase was charged and discharged between 0.2V and 1.1V versus Ag/AgCl reference electrode using cyclic voltammetry at a scan rate of 2, 5 and 10 mV/S.

Although embodiments of the invention have been described, it is understood that the present invention should not be limited to those embodiments, but various changes and modifications can be made by one skilled in the art within the spirit and scope of the invention as hereinafter claimed.

What is claimed is:

1) A Metal/Ion Pseudo-Capacitor (MIPC) comprises a multi-functional electrolyte, an anode deposition substrate (ADS), a cathode, a cathode current collector, a separator function, an anode current collector function, and packaging;
wherein said MIPC stores electric charge by employing a multi-functional electrolyte comprising at least one redox-active cation component (M) which provides anode functionality through reversible metal electro-deposition and dissolution processes that occur upon the electrochemically active surface of said ADS, and pairs this with said cathode employing ion adsorption/desorption processes, faradaic processes or both faradaic and adsorption/desorption processes;
wherein the multi-functional electrolyte comprises at least one cation species, at least one anion species, an ion conduction medium, and at least one phase selected from a group consisting of liquid, gel, solid, and combinations thereof;
wherein said gel further comprises at least one gel agent selected from a group comprising an organic compound, a polymer, an inorganic compound, silica, and combinations thereof;
wherein the composition of said multi-functional electrolyte is selected from a group consisting of ionic liquid, salt and liquid solvent, salt and gel solvent, salt and solid state ion conductor, and combinations thereof,
wherein the liquid solvent is at least one selected from a group consisting of water and organic liquid.

2) The MIPC multi-functional electrolyte of claim 1
wherein said multi-functional electrolyte contains:
redox-active cation M at least one selected from a group consisting of cation species of Sn, Ni, Co, Ti, In, Pb, Cr, Fe, Ga, Ta, Zn, Nb, V, Mn, Zr, Al, Mg, Na, Ca, Sr, Ba, K, Li and H; and
at least one anion species selected from a group consisting of Cl⁻, SO₄²⁻, NO₃⁻, OH⁻, TFSI⁻, FSI⁻, PF₆⁻, CF₃SO₃⁻, CH₃SO₃⁻, BOB⁻, FAP⁻, BF₄⁻, ClO₄⁻, AsF₆⁻, Br⁻; I⁻, BETI⁻, DCTA⁻, TDI⁻, AlCl₄⁻, SbF₆⁻, SCN⁻, CF₃CO₂⁻, (CF₃SO₂)₂⁻, N(CF₃SO₂)₂⁻, NTf₂⁻, and B(C₆H₅)₄⁻;
wherein said organic liquid solvent is at least one selected from a group consisting of EC, FEC, PC, DEC, DE, DME, EMC, DMC, EG, DGD, DGDE, DEBD, DPGDME, DEE, BEE, TMS, FMS, DMSO, AN, THF, 2-Me THF, MF, GBL, AND, SCN, GLN, PMN, SUN, SEN, MFE, TMMP, TPTP, and TTFP;
wherein said ionic liquid is derived from at least one organic compound ion family selected from a group consisting of imidazolium, pyridinium, pyrrolidinium, pyrazolium, and phosphonium;
wherein said electrolyte polymer component is at least one selected from a group consisting of PMMA, PVA, PSO, PEO, PSU, PMEO, PI, PA, PET, PP, PEN, PEG, PC, PAN, PPS, PTFE, PVDF, PAAK, PAAM, fumed silica; and cellulose.

3) The MIPC multi-functional electrolyte of claim 1 containing at least one cation species (C) in addition to M, such that the additional cation species C is not the principal anode charge storage cation M of the MIPC, and is selected from a group consisting of cation species of Sn, Ni, Co, Ti, In, Pb, Cr, Fe, Ga, Ta, Zn, Nb, V, Mn, Zr, Al, Mg, Na, Ca, Sr, Ba, K, Li, N, Bi, Ge, Cu, H, hydronium, ammonium, and organic complex.

4) The MIPC ionic liquid of claim 1 is at least one selected from a group consisting of EMITFSI, EMIBF₄, EMIM OTf, EMIM BTA, PMPyrr BTA, EMIM-NTf₂, PYR₁₃TFSI, 1-allyl-3-methylimidazolium tetrachloroaluminate, 1-(3-cyanopropyl)pyridinium tetrachloroaluminate, 1-butyl-1-methylpyrrolidinium tetraaluminate, 1,2,4-trimethylpyrazolium tetraaluminate, and triphenylmethylphosphonium tetraaluminate.

5) The MIPC separator function of claim 1 allows the transport of ionic species contained in the electrolyte to and from the electrochemically active surfaces of the ADS and the cathode while obstructing electron flow between the cathode and ADS, wherein said separator function comprises material selected from a group consisting of:
a solid polymer electrolyte;
a gel polymer electrolyte;
a solid ceramic electrolyte comprising one or more of the elements Na, Al, Ti, Zr, Ca, Mg, Ge, In, Li, Zn, Si, Y, Ce, Hf, and one or more of the elements H, O, P, S, and N;
a porous separator sheet comprising at least one material selected from a group consisting of PET, PP, PEN, PC, PPS, PTFE, PVDF, cellulose fiber, glass fiber, and absorbed glass mat;
a barrier coating which is adhered to the electrochemically inactive surfaces of the ADS for the purpose of preventing contact between said inactive ADS surfaces and the electrolyte, thereby preventing said inactive ADS surfaces from participating in electro-deposition/dissolution processes, a second purpose of said barrier coating is to prevent electrical contact between the ADS and cathode, such barrier coating comprises at least one layer of at least one material selected from a group consisting of inorganic material, ceramic material, organic material, epoxy, plastic, nylon, and polymer;
a spacer coating which is adhered to the selected surfaces of the ADS for the purpose of providing a controlled distance between electrochemically active ADS surfaces and cathode, thereby preventing electrical contact between the ADS and cathode, such spacer coating comprises at least one material selected from a group consisting of inorganic material, ceramic material, organic material, epoxy, plastic, nylon, and polymer; and
any combination thereof.

6) The MIPC ADS of claim 1 comprises electrochemically active surfaces or electrochemically active surfaces and electrochemically inactive surfaces, and further comprises at least one material selected from a group consisting of
glassy carbon, graphitic carbon,
solid state metal of M or alloy of M, and
a solid state material comprises material A or any combination of material A and material B,
wherein material A comprises one or more selected from a group consisting of Sn, Ni, Co, Ti, In, Pb, Cr, Fe, Ga, Ta, Zn, Nb, V, Mn, Zr, Al, Mg, Na, Ca, Sr, Ba, K, Li, Cu, and alloys thereof,
wherein material B comprises one or more selected from a group consisting of Bi, Ge, Si, O, P, N, Ga, Mo, C, B, S, Sb, and Se;
wherein the mechanical form of said ADS comprises one form or any combination of forms selected from a group consisting of layered laminate, foil, textured foil, patterned foil, etched foil, perforated foil, honeycomb foil, expanded foil, wire mesh, solid foam structure, polymer-bound foam powder composite, solid structure formed from sintered or melted powder, and polymer-bound powder composite.

7) The MIPC anode current collector function of claim 1 comprises
a/ the aforementioned ADS, or
b/ a current collector which is separate from the aforementioned ADS, said separate anode current collector is physically and electrically in contact with said ADS;
wherein the mechanical form of said separate anode current collector is one or any combination of forms selected from a group consisting of foil, textured foil, patterned foil, etched foil, perforated foil, honeycomb foil, expanded foil, a layered laminate, wire mesh, solid foam structure, polymer-bound foam powder composite, solid structure formed from sintered or melted powder, and polymer-bound powder composite;
wherein said separate anode current collector comprises at least one material selected from a group consisting of
glassy carbon, graphitic carbon, and
a solid state material comprising material A or any combination of material A and material B,
wherein material A comprises one or more selected from a group consisting of Sn, Ni, Co, Ti, In, Pb, Cr, Fe, Ga, Ta, Zn, Nb, V, Mn, Zr, Al, Mg, Na, Ca, Sr, Ba, K, Li, Cu, and alloys thereof,
wherein material B comprises one or more selected from a group consisting of Bi, Ge, Si, O, P, N, Ga, Mo, C, B, S, Sb, and Se.

8) The MIPC cathode of claim 1 active material is at least one selected from a group consisting of transition metal hexacyanometalate, carbon, functionalized carbon, electro-active polymer, doped electro-active polymer, and combinations thereof;
wherein the transition metal hexacyanometalate cathode
further comprises the physical form of composite further comprising said transition metal hexacyanometalate powder, a binder material and a conductivity enhancing carbon,
further comprises at least one transition metal hexacyanometalate active material with the simplified chemical form A^{va}ₐ(M₁^{v1})_{b}[M₂^{v2}(CN)_{c}]_{d}*xH₂O where “A” is an insertion cation of valence “va” of an alkali metal, an alkaline earth metal, a proton or ammonium, where “M₁” is a metal ion of valence “v1”, where “M₂” is a metal ion of valence “v2”, where “a”, “b”, “c”, and “d” represent stoichiometry of the complex, and where “x” represents the stoichiometry of coordinated water molecules, where M₁ is at least one element selected from a group consisting of Mn, Ni, Co, Fe, Al, Cr, Mo, V, W, Ta, Pb, Sn, Ti, Cu, Zn, and Nb, where M₂ is least one element selected from a group consisting of Mn, Ni, Co, Fe, Al, Cr, Mo, V, W, Ta, Pb, Sn, Ti, Cu, Zn, and Nb,
further comprises at least one transition metal hexacyanometalate active material with an average thickness of said powder particles is greater than about 5 nanometers and less than about 10 micrometers;
wherein the carbon cathode
further comprises the physical form of a monolith or a composite further comprising said carbon active material powder, a binder and a conductivity enhancing carbon,
said carbon active material powder further comprises a specific surface area greater than about 200 m²/g and less than about 3000 m²/g,
said carbon active material powder further comprises at least one active material selected from a group consisting of porous carbon, carbon microfibers, carbon nanofibers, carbon nanotubes, graphene, reduced graphene oxide, graphite, carbon black, and a carbon material derived from any combination thereof;
wherein the functionalized carbon cathode
further comprises the physical form of a monolith or a composite further comprising said functionalized carbon active material powder, a binder and a conductivity enhancing carbon,
said functionalized carbon further comprises a specific surface area greater than about 100 m²/g and less than about 3000 m²/g,
said functionalized carbon further comprises at least one carbon material selected from a group consisting of porous carbon, carbon microfibers, carbon nanofibers, carbon nanotubes, graphene, reduced graphene oxide, graphite, carbon black, and a carbon material derived from any combination thereof, and
at least one functionalizing agent, the incorporation of said functionalizing agent with said carbon material is one or more selected a group consisting of a dopant, a physical mixture within said carbon matrix, a deposit upon said carbon surface, or any combination thereof,
wherein said functionalizing agent incorporated as a dopant comprises at least one P-block element selected from a group consisting of B, N, O, F, Si, P, S, Cl, Ga, Ge, Se, Br, and I,
wherein said functionalizing agent incorporated as a physical mixture within said carbon matrix comprises at least one inorganic compound selected from a group containing material A and material B, or a combination of material A, material B and at least one cation species, wherein material A is selected from a group consisting of Mn, Ni, Co, Fe, Al, Cr, Mo, V, W, Ta, Pb, Sn, Ti, Cu, Zn, Nb, Si, Na, K, Li, and any combination thereof, and material B is selected from a group of consisting of O, H, P, C, N, S and any combination thereof,
wherein the surface deposit comprises at least one selected from a group comprising transition metal hexacyanometalate, inorganic compound, electro-active polymer, electro-active polymer which is doped with at least one inorganic species, and any combination thereof,
wherein said transition metal hexacyanometalate deposit comprises at least one metal hexacyanometalate taking the simplified chemical form A^{va}ₐ(M₁^{v1})_{b}[M₂^{v2}(CN)_{c}]_{d}*xH₂O where “A” is an insertion cation of valence “va” of an alkali metal, an alkaline earth metal, a proton or ammonium, where “M₁” is a metal ion of valence “v1”, where “M₂” is a metal ion of valence “v2”, where “a”, “b”, “c”, and “d” represent stoichiometry of the complex, and where “x” represents the stoichiometry of coordinated water molecules, where M₁ is at least one element selected from a group consisting of Mn, Ni, Co, Fe, Al, Cr, Mo, V, W, Ta, Pb, Sn, Ti, Cu, Zn, and Nb, where M₂ is least one element selected from a group consisting of Mn, Ni, Co, Fe, Al, Cr, Mo, V, W, Ta, Pb, Sn, Ti, Cu, Zn, and Nb,
wherein said inorganic compound deposit contains material A and material B, or a combination of material A, material B and at least one cation species, wherein material A is selected from a group of consisting of Mn, Ni, Co, Fe, Al, Cr, Mo, V, W, Ta, Pb, Sn, Ti, Cu, Zn, Nb, Si, Na, K, Li, and any combination thereof, and material B is selected from a group of consisting of O, H, P, C, N, S and any combination thereof,
wherein said electro-active polymer deposit comprises one or more of a redox polymer or a conductive polymer, said electro-active polymer is selected from a group consisting of PPy, PANI, PEDOT, POMA, PDAAQ, PQ, PIn, CIT, PAC, PA, PVPy, tetramethylpyridine, PT, and derivatives and combinations thereof,
wherein said doped electro-active polymer comprises one or more of a redox polymer or a conductive polymer, said electro-active polymer is selected from a group consisting of PPy, PANI, PEDOT, POMA, PDAAQ, PQ, PIn, CIT, PAC, PA, PVPy, tetramethylpyridine, PT, and derivatives and combinations thereof, and at least one dopant element selected from a group consisting of O, H, P, C, N, S, Mn, Ni, Co, Fe, Al, Cr, Mo, V, W, Ta, Pb, Sn, Ti, Cu, Zn, Nb, Na, K, Mg, Ca, and Li,
wherein the average thickness of said surface deposit is greater than about 5 nanometers and less than about 1000 nanometers;
wherein the electro-active polymer cathode
further comprises the physical form of a composite further comprising said electro-active polymer powder, a binder material and a conductivity enhancing carbon,
said electro-active polymer powder further comprises average particle thickness of said electro-active polymer powder is greater than about 5 nanometers and less than about 10 micrometers,
said electro-active polymer powder further comprises one or more of a redox polymer or a conductive polymer,
one or more is selected from a group consisting of PPy, PANI, PEDOT, POMA, PDAAQ, PQ, PIn, CIT, PAC, PA, PVPy, tetramethylpyridine, PT, and derivatives and combinations thereof,
wherein the dopant of said doped electro-active polymer is at least one element selected from a group consisting of O, H, P, C, N, S, Mn, Ni, Co, Fe, Al, Cr, Mo, V, W, Ta, Pb, Sn, Ti, Cu, Zn, Nb, Na, K, Mg, Ca, and Li.

9) The MIPC cathode current collector of claim 1 is physically attached and electrically in contact with said cathode;
wherein said cathode current collector comprises at least one form selected from a group consisting of foil, laminated foil composite, textured foil, patterned foil, etched foil, perforated foil, honeycomb foil, expanded foil, wire mesh, solid foam structure, polymer-bound foam powder composite, solid structure formed from powder, and polymer-bound powder composite;
wherein said cathode current collector comprises at least one material selected from a group consisting of
glassy carbon, graphitic carbon, and
a solid state material comprising material A or any combination of material A and material B,
wherein material A comprises one or more selected from a group consisting of Sn, Ni, Co, Ti, In, Pb, Cr, Fe, Ga, Ta, Zn, Nb, V, Mn, Zr, Al, Mg, Na, Ca, Sr, Ba, K, Li, Cu, and alloys thereof,
wherein material B comprises one or more selected from a group consisting of Bi, Ge, Si, O, P, N, Ga, Mo, C, B, S, Sb, and Se.

10) An energy storage device comprising one or a plurality of MIPC cells,
wherein said plurality of MIPC cells are combined with one or more additional energy device selected from a group consisting of MIPC, battery, fuel cell, energy conversion device, and any combination thereof;
wherein said combination is an electrical configuration selected from a group consisting of series, parallel, and any combination thereof.

11) A method for preparing a MIPC comprising i) preparation of an anode deposition substrate (ADS), ii) preparation of a cathode and current collector, and iii) combination of the ADS, cathode and a multi-functional electrolyte with separator and packaging materials to form a MIPC;
wherein the ADS is first formed and prepared prior to MIPC assembly, said preparation comprises the treatment of the electro-active surfaces of the ADS to remove impurities, oxidation and other passivation inducing products from said surfaces, thereby increasing and improving the deposition nucleation sites and the dissolution sites, said treatment by at least one method selected from a group consisting of mechanical, chemical, sonication, electrochemical, and combinations thereof;
wherein the prepared ADS is first attached to an anode current collector by means selected from a group consisting of applying heat, applying pressure, applying a conductive adhesive, welding, sintering, and combinations thereof;
wherein the combination of materials forming a MIPC comprises
a/ placing at least one cathode and current collector assembly, at least one ADS, a multi-functional electrolyte, and a separator within a packaging material further comprising at least a case, at least one positive terminal, at least one negative terminal, and at least one pressure release valve;
b/ placing the same under vacuum; and
c/ sealing the MIPC.

12) The method for preparing a cathode and current collector assembly for a MIPC according to claim 11, wherein the form of said cathode and current collector assembly is at least one selected fro a group consisting of i) composite cathode, ii) monolithic cathode and iii) integral monolithic cathode and current collector;
wherein said composite cathode and current collector is first prepared prior to MIPC assembly, said preparation comprises
a/ preparing said cathode current collector prior to the application of the cathode film for the purpose of removing impurities, oxidation and other passivation inducing products from said surfaces, thereby improving the interfacial resistance and adherence, said preparation is by at least one method selected from a group consisting of mechanical, chemical, sonication, electrochemical, heat application, and combinations thereof,
b/ admixing the cathode active material powder, conductivity enhancing carbon, solvent and binder to form a slurry or paste, and
c/ creating at least one free-standing cathode film by rolling and heating said paste, which free-standing film is subsequently bonded to said current collector, or by casting said slurry or paste onto the cathode current collector and bonding thereto, said bonding by means selected from a group consisting of applying heat, applying pressure, applying a conductive adhesive, and combinations thereof,
wherein said binder is selected from a group consisting of a resin, a polymer, PTFE, PVDF, PVA, and combinations thereof;
wherein said solid monolith carbon cathode structure and current collector is first prepared prior to MIPC assembly, said preparation comprises
a/ preparing said cathode current collector prior to the application of the cathode film for the purpose of removing impurities, oxidation and other passivation inducing products from said surfaces, thereby improving the interfacial resistance and adherence, said preparation is by at least one method selected from a group consisting of mechanical, chemical, sonication, electrochemical, heat application, and combinations thereof, and
b/ attaching a one or more solid monolithic cathode carbon structures upon at least one side of said cathode current collector and bonding the same to said current collector by means selected from a group consisting of applying heat, applying pressure, applying a conductive adhesive, and combinations thereof;
wherein said integral monolith cathode and current collector is first prepared prior to MIPC assembly, said preparation comprises
a/ preparing cathode current collector material selected from a group consisting of one or more sheets of graphite foil, and
a laminate of two or more sheets of graphite foil with at least one metal layer therebetween and an edge sealant wherein said metal is melted or is partially melted or is sintered upon the facing surfaces of said graphite foil sheets thereby maintaining mechanical integrity and electrical conductivity of said laminate,
b/ preparing the surface of said cathode current collector prior to the application of cathode precursor material for the purpose of removing impurities, oxidation and other passivation inducing products from said surfaces, thereby improving the interfacial resistance and adherence between the cathode and current collector, said preparation is by at least one method selected from a group consisting of mechanical, chemical, sonication, electrochemical, heat application, and combinations thereof,
c/ preparing monolithic carbon cathode precursor, said carbon is formed by a method selected from a group consisting of templated carbon, polymer-derived carbon, or any combination thereof,
d/ forming a cathode assembly comprising one or more solid monolithic cathode carbon precursor structures upon at least one side of said cathode current collector thereby simultaneously creating carbon monolith precursor structure and bonding the same to said current collector,
d/ pyrolizing at a temperature of at least about 500 degrees C. under an inert atmosphere, said cathode assembly comprising one or more carbon monolith precursor structures and said current collector so as to convert said monolithic carbon cathode precursor structures to carbon which is bonded to said current collector, and
e/ rinsing said cathode assembly to remove impurities and precursor materials.
